(19) United States
(12) Patent Application Publication
(10) Pub. No.: US 2007/0070235 A1
(43) Pub. Date: Mar. 29, 2007

(54) Drive unit, optical controller, and image taking apparatus

(75) Inventors: Akihiro Maejima, Asaka (JP); Naoyuki Nishikawa, Asaka (JP); Kazuhiko Onda, Saitama (JP); Jun Hiraku, Saitama (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/519,038

(22) Filed: Sep. 12, 2006

(30) Foreign Application Priority Data
Sep. 27, 2005 (JP) 2005-280234

(51) Int. Cl. G02B 13/16

(52) U.S. Cl. 348/335

(57) ABSTRACT

An optical controller has a lens to be driven, a holding section which holds the lens and is movable in a driving direction of the lens, a polymer actuator which drives the holding section in the driving direction by expanding and contracting in response to application and release of a voltage, and a control section which controls a position of the lens by controlling application and release of a voltage with respect to the polymer actuator.

### BACKGROUND OF THE INVENTION

1. Field of the Invention

The present invention relates to a drive unit which drives a driven object, an optical controller which causes a lens to be driven along an optical axis, and an image taking apparatus which shoots an image formed by a subject light.

2. Description of the Related Art

Recently, zoom and autofocus functions have come into use not only in regular-size cameras, but also in small image taking units mounted on cell phones and the like, making it necessary to drive lenses even in such small image taking units. Consequently, these small image taking units are required to reduce size and weight of the lens drive system itself.

Regarding drive units which drive camera lenses, those which have been proposed include one that transmits rotatory power of a motor to the lens via a wire (e.g., Japanese Patent Laid-Open No. 58-40735) and one that transmits rotatory power of a motor to the lens via a screw-based transmission mechanism (e.g., Japanese Patent Laid-Open No. 8-122613).

However, the drive units disclosed in Japanese Patent Laid-Open Nos. 58-40735 and 8-122613 have a problem in that the transmission mechanism which transmits the driving force to the lens are complex, which increases the size and weight of the drive units, in addition to the size and weight of the motor itself used to generate the driving force. Also, they have a problem in terms of noise originated from vibration due to rotation of the motor and operation of the transmission mechanism.

### SUMMARY OF THE INVENTION

The present invention has been made in view of the above circumstances and provides a small and lightweight drive unit which drives a driven object quietly, a small and lightweight optical controller which causes a lens to be driven along an optical axis quietly, and a small and lightweight image taking apparatus in which a lens is driven along an optical axis quietly.

The present invention provides a drive unit including:

a holding section which holds a driven object and is movable in a driving direction of the driven object; and

a polymer actuator which drives the holding section in the driving direction by expanding and contracting in response to application and release of a voltage.

The drive unit according to the present invention uses the expansion and contraction of the polymer actuator to drive the driven unit. Generally, polymer actuators are small and lightweight. Besides, they expand and contract quietly. Thus, the present invention provides a small and lightweight drive unit which drives a driven object quietly.

In the drive unit according to the present invention, preferably the polymer actuator expands and contracts by amounts corresponding to a magnitude of the applied voltage.

By varying the magnitude of the voltage applied to the polymer actuator, the preferred form of the drive unit makes it possible to vary the distance traveled by the driven object.

Also, in the drive unit according to the present invention, preferably the polymer actuator is a laminated polymer actuator made up of a stack of multiple elastic members which expand and contract in response to application and release of a voltage.

By varying the number of elastic members to which a voltage is applied out of the stack of elastic members, the preferred form of the drive unit makes it possible to vary the amount of expansion or contraction of the polymer actuator, and thereby vary the distance traveled by the driven object.

Also, in the drive unit according to the present invention, preferably the polymer actuator is made of an electrostrictive polymer or liquid crystal elastomer.

Polymers available for use in polymer actuators include polymer gels, ion conducting polymers, electron conducting polymers, electrostrictive polymers (dielectric elastomers and electrostatic elastomers), piezoelectric polymers, and liquid crystal elastomers. Above all, electrostrictive polymers and liquid crystal elastomers are preferable because of their particularly rapid responsiveness to application of voltages.

Also, preferably the drive unit according to the present invention further includes a driving section which drives the holding section in the driving direction, in addition to the polymer actuator, wherein the driving section drives the holding section in the direction opposite to the driving direction of the holding section by the polymer actuator.

The polymer actuator exerts a higher force in either the expansion or contraction depending on its shape. The preferred form of the drive unit utilizes the higher expansive or contractile force of the polymer actuator in driving the holding section in one direction while using the driving section for driving in the opposite direction. This configuration allows properties of the polymer actuator to be used more effectively.

Also, in the drive unit according to the present invention, more preferably the driving section is installed on an opposite side of the holding section from the polymer actuator.

By placing the driving section and the polymer actuator in a line, for example, in the driving direction, this more preferred form makes it possible to further downsize the drive unit.

Also, in the drive unit according to the present invention, it is acceptable that the driving section is a spring which drives the holding section by a biasing force; or

the driving section is a polymer actuator which drives the holding section by expanding and contracting in response to application and release of a voltage.

In the former form, the holding section is driven in opposite directions by the polymer actuator and the spring. In the latter form, the holding section is driven in opposite directions by two polymer actuators.

Also, the present invention provides an optical controller including:

a lens to be driven;

a holding section which holds the lens and is movable in a driving direction of the lens;

a polymer actuator which drives the holding section in the driving direction by expanding and contracting in response to application and release of a voltage; and

a control section which controls a position of the lens by controlling application and release of a voltage with respect to the polymer actuator.

The present invention can provide a small and lightweight optical controller which makes the lens to be driven along the optical axis quietly.

Incidentally, only a basic form of the optical controller according to the present invention is described here, but the optical unit according to the present invention includes various forms corresponding to the various forms of the drive unit described earlier, in addition to the basic form described above.

Also, the present invention provides an image taking apparatus including:

a lens which is driven to focus a subject light;

a holding section which holds the lens and is movable in a driving direction of the lens;

a polymer actuator which drives the holding section in the driving direction by expanding and contracting in response to application and release of a voltage;

a control section which controls a position of the lens by controlling application and release of a voltage with respect to the polymer actuator; and

an image taking section which shoots an image formed by the a subject light through the lens.

The present invention can provide a small and lightweight image taking apparatus in which a lens is driven along an optical axis quietly.

Also, it is acceptable that the image taking apparatus according to the present invention includes a contrast detecting section which detects contrast of the image shot by the image taking section, wherein the control section controls the position of the lens according to the contrast detected by the contrast detecting section.

This form of the image taking apparatus quietly performs focus adjustment which involves controlling the position of the lens according to the contrast.

Again, only a basic form of the optical controller according to the present invention is described here, but the optical controller according to the present invention includes various forms corresponding to the various forms of the drive unit described earlier, in addition to the basic form described above.

As described above, the present invention provides a small and lightweight drive unit which drives a driven object quietly, a small and lightweight optical controller which causes a lens to be driven along an optical axis quietly, and a small and lightweight image taking apparatus in which a lens is driven along an optical axis quietly.

### BRIEF DESCRIPTION OF THE DRAWINGS

FIG. 1 is an external perspective view of a digital camera to which the first to ninth embodiments of the present invention apply commonly;

FIG. 2 is an external perspective view of a digital camera to which the first to ninth embodiments of the present invention apply commonly;

FIG. 3 is a sectional view of a collapsed lens barrel 10 of the digital camera 1 taken along an optical axis;

FIG. 4 is a sectional view of the lens barrel 10 of the digital camera 1 taken along the optical axis with the image taking lens located at a Wide end;

FIG. 5 is a sectional view of the lens barrel 10 of the digital camera 1 taken along the optical axis with the image taking lens located at a Tele end;

FIG. 6 is a schematic diagram showing an internal configuration of the digital camera 1 shown in FIG. 1;

FIG. 7 is a diagram showing a drive unit and voltage application section according to the first embodiment of the present invention;

FIG. 8 is a diagram showing details of the polymer actuator 513 and voltage application section 610 shown in FIG. 7;

FIG. 9 is a diagram showing a drive unit and voltage application section according to the second embodiment of the present invention;

FIG. 10 is a diagram showing details of the laminated polymer actuator 523 and voltage application section 620 shown in FIG. 9

FIG. 11 is a diagram showing a drive unit and voltage application section according to the third embodiment of the present invention;

FIG. 12 is a diagram showing a drive unit and voltage application section according to the fourth embodiment of the present invention;

FIG. 13 is a diagram showing a drive unit and voltage application section according to the fifth embodiment of the present invention;

FIG. 14 is a diagram showing a drive unit and voltage application section according to the sixth embodiment of the present invention;

FIG. 15 is a diagram showing details of the two polymer actuators 563 and 564 and voltage application section 660 shown in FIG. 14;

FIG. 16 is a diagram showing a drive unit and voltage application section according to the seventh embodiment of the present invention;

FIG. 17 is a diagram showing details of the two laminated polymer actuators 573 and 574 and voltage application section 670 shown in FIG. 16;

FIG. 18 is a diagram showing a drive unit and voltage application section according to the eighth embodiment of the present invention;

FIG. 19 is a diagram showing details of the polymer actuator 583 and voltage application section 680 shown in FIG. 18;

FIG. 20 is a diagram illustrating deformation of a liquid crystal elastomer in an electric field;

FIG. 21 is a diagram showing a drive unit and voltage application section according to the ninth embodiment of the present invention; and

FIG. 22 is a diagram showing details of the two polymer actuators 593 and 594 and voltage application section 690 shown in FIG. 21.

### DETAILED DESCRIPTION OF THE INVENTION

Embodiments the present invention will be described below with reference to the drawings.

First, description will be given of a digital camera to which first to ninth embodiments apply commonly.

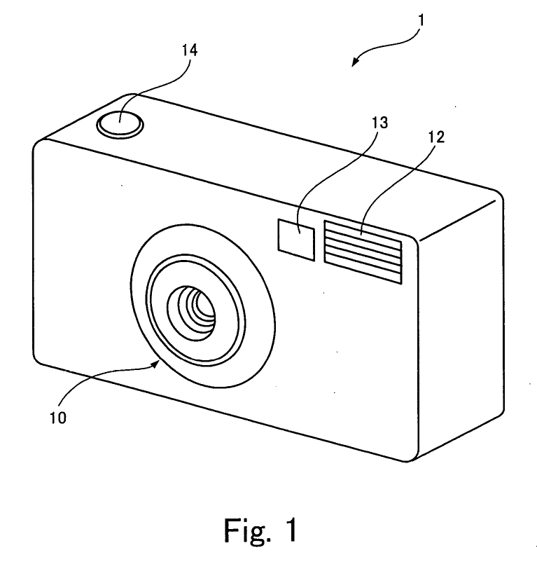

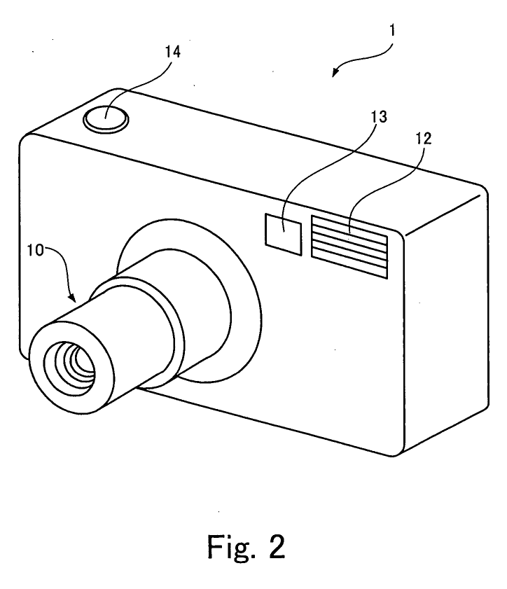

FIGS. 1 and 2 are external perspective views of the digital camera to which the first to ninth embodiments of the present invention apply commonly.

FIG. 1 shows a lens barrel 10 of the digital camera 1 in its collapsed state, where the lens barrel 10 incorporates an image taking lens. FIG. 2 shows the lens barrel 10 in its extended state. The digital camera 1 in FIGS. 1 and 2 is an example of the image taking apparatus according to the present invention.

On the upper front part of the digital camera 1 shown in FIGS. 1 and 2, there are a fill flash window 12 and finder objective window 13. On the top face of the digital camera 1, there is a shutter button 14.

Various switches such as a zoom control switch and cross-key pad as well as an LCD (liquid crystal display) for use to display images and a menu screen are mounted on the back (not shown) of the digital camera. If the zoom control switch is held down for a predetermined time or longer, the digital camera 1 enters a zoom control mode in order to adjust the angle of view. While an Up key of the cross-key pad is held down, an image taking lens (described later) moves to a telephoto side (Tele side). While a Down key of the cross-key pad is held down, the image taking lens moves to a wide-angle side (Wide side).

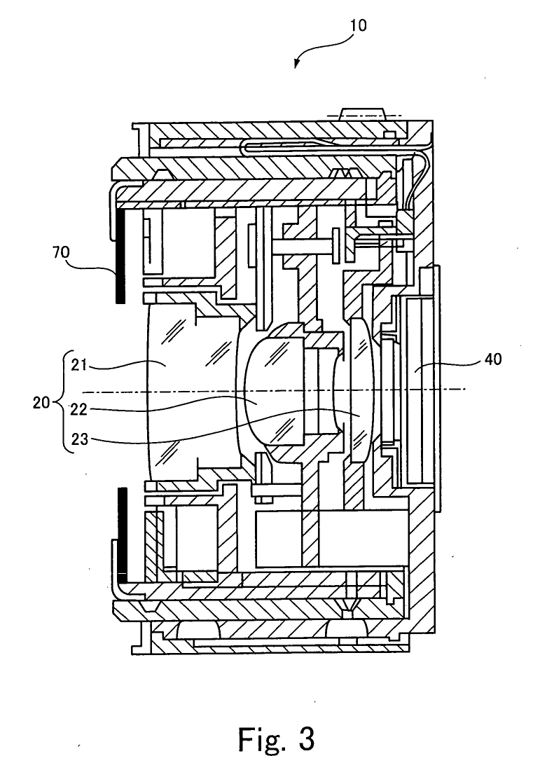

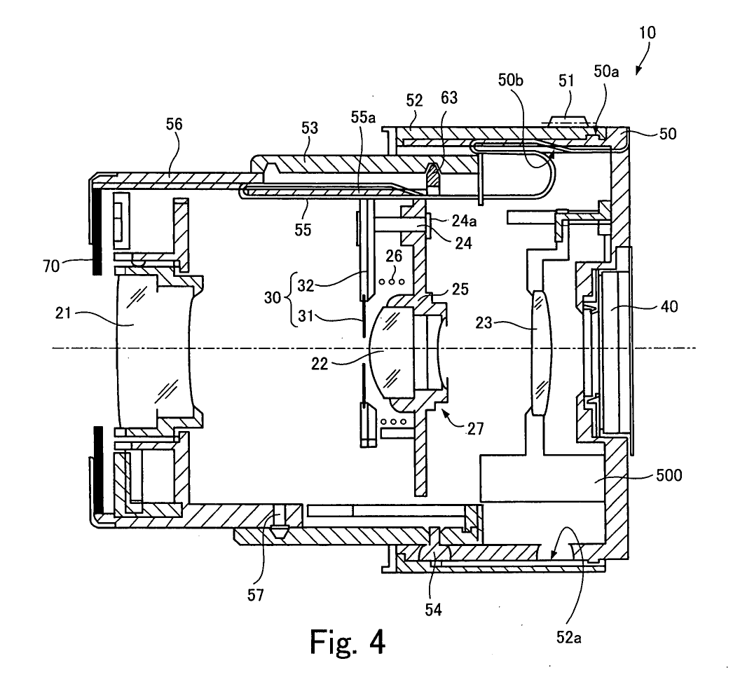

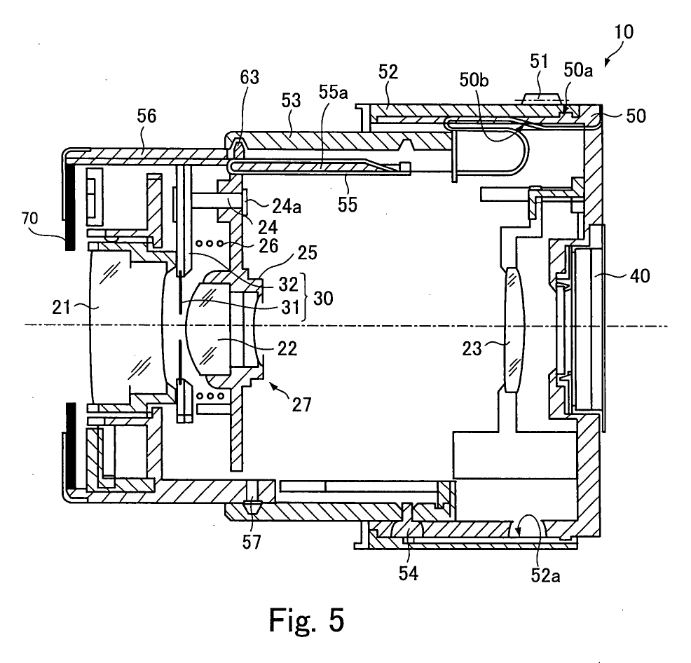

FIG. 3 is a sectional view of the collapsed lens barrel 10 of the digital camera 1 taken along the optical axis, FIG. 4 is a sectional view of the lens barrel 10 of the digital camera 1 taken along the optical axis with the image taking lens located at the Wide end, and FIG. 5 is a sectional view of the lens barrel 10 of the digital camera 1 taken along the optical axis with the image taking lens located at the Tele end.

The lens barrel 10 contains in its interior space the image taking lens 20 which consists of a front-group lens (first lens group) 21, rear-group lens (second lens group) 22, and focus lens (third lens group) 23 arranged from front to rear in this order with their optical axes aligned. The image taking lens 20 is configured such that the rear-group lens 22 moves along the optical axis between the Wide end shown in FIG. 4 and Tele end shown in FIG. 5 for focal length adjustment and that the focus lens 23 moves along the optical axis for focus adjustment. A flare prevention plate 70 is placed further ahead of the front-group lens 21 to shut out harmful rays, an iris unit 30 is placed between the front-group lens 21 and rear-group lens 22 to adjust light quantity of a subject light, and a CCD 40 is placed behind the image taking lens 20 to read the a subject light. The focus lens 23 is an example of the lens according to the present invention. It is held and driven along the optical axis by a drive unit (described later).

As shown in FIGS. 4 and 5, the iris unit 30 has an aperture plate 32 in which a hole is made around the optical axis of the image taking lens 20 and iris leaves 31 which adjust the amount of opening by throttling the hole in the aperture plate 32. Also, the iris unit 30 has a guide rod 24 which protrudes backward from the back of the iris unit 30 and a stopper 24a which is attached to the rear end of the guide rod 24. The guide rod 24 penetrates a rear-group lens holder frame 25 that holds the rear-group lens 22 in such a way that the rear-group lens holder frame 25 can slide along the optical axis. Furthermore, a coil spring 26 is mounted in compression between the iris unit 30 and rear-group lens holder frame 25 and the iris unit 30 is held in such a way that the iris unit 30 can slide along the optical axis, being spring-biased forward against a rear-group lens unit 27 composed of the rear-group lens 22 and rear-group lens holder frame 25. When the lens barrel 10 is collapsed, the iris leaves 31 shown in FIGS. 4 and 5 are opened and the iris unit 30 moves toward the rear-group lens unit 27, compressing the coil spring 26 and thereby pushing the rear-group lens unit 27 into the hole in the aperture plate 32. This makes it possible to reduce the thickness of the digital camera 1.

Also, the lens barrel 10 has a fixed tube 50 fixed to the camera body and a driving tube 52 rotatable around the fixed tube 50. Movement of the driving tube 52 along the optical axis with respect to the fixed tube 50 is restricted by engageable insertion of a ridge 50a formed circumferentially on an outer surface of the fixed tube 50 into a groove formed in an inner surface of the driving tube 52. The driving tube 52 is rotated by a rotational driving force transmitted from a motor (not shown) via a gear 51 on an outer surface of the driving tube 52.

Furthermore, the driving tube 52 has a keyway 52a which extends along the optical axis, and a pin-like cam follower 54 mounted on a rotational tube 53 is engageably inserted in the keyway 52a through a spiral cam groove cut in the fixed tube 50. Consequently, when the driving tube 52 rotates, the rotational tube 53 moves in the direction of the optical axis, rotating along the cam groove.

A translatory frame 55 is installed inside the rotational tube 53. The translatory frame 55 is engaged with the rotational tube 53 in such away as to allow relative rotation. It has its movement restricted by being engageably inserted into a keyway 50b of the fixed tube 50. Consequently, when the rotational tube 53 moves in the direction of the optical axis, rotating along with rotation of the driving tube 52, the translatory frame 55 moves linearly in the direction of the optical axis along with the rotation of the rotational tube 53.

A pin-like cam follower 63 is mounted on the rear-group lens holder frame 25 which holds the rear-group lens 22. The pin-like cam follower 63 is engageably inserted in the cam groove of the rotational tube 53 as well as in a keyway 55a of the translatory frame 55. Consequently, when the rotational tube 53 moves in the direction of the optical axis, rotating along with rotation of the driving tube 52, the rear-group lens unit 27 moves straight in the direction of the optical axis, following the shape of the cam groove in the rotational tube 53.

Since the iris unit 30 is mounted on the lens unit 27, being biased forward by the coil spring 26 as described above, the iris unit 30 moves in the direction of the optical axis together with the lens unit 27.

Furthermore, the lens barrel 10 has a translatory tube 56 which holds the front-group lens 21. A cam follower 57 mounted on the translatory tube 56 is engageably inserted in the cam groove of the rotational tube 53 as well as in the keyway 55a of the translatory frame 55, with the keyway 55a extending along the optical axis. Consequently, when the rotational tube 53 moves in the direction of the optical axis, rotating along with rotation of the driving tube 52, the translatory tube 56 moves straight in the direction of the optical axis, following the shape of the cam groove in the rotational tube 53 in which the cam follower 57 is engageably inserted.

The lens barrel 10 is extended in this way, and it is collapsed when the driving tube 52 rotates in the opposite direction.

Even after the lens barrel 10 completes its extension, the rotational tube 53 can further rotate while maintaining the position of the front-group lens 21. At this time, the rear-group lens unit 27 moves in the direction of the optical axis along the cam groove of the rotational tube 53, adjusting the angle of view (and thus, the focal length). FIG. 4 shows the lens barrel 10 at the completion of its extension. At this time, the image taking lens 20 is located at the Wide end. FIG. 5 shows a state which takes place as the rotational tube 53 rotates further after the completion of the extension, moving the rear-group lens unit 27 until the image taking lens 20 is located at the Tele end.

The focus lens 23 in the image taking lens 20 is moved along the optical axis by a drive unit 500 which is an example of the drive unit according to the present invention, thereby adjusting focus. The focus adjustment is made by moving the focus lens 23 in such a way that the contrast of a subject image read by the CCD 40 will reach its peak (described later). This type of focus adjustment involves frequent movement of the focus lens 23, and thus the digital camera 1 employs the drive unit 500 which can move the focus lens quietly.

The drive unit 500 shown in FIGS. 3 to 5 and FIG. 6 (described later) is an abstract representation of nine examples of the drive unit according to the present invention. Each of the nine examples will be described in detail later.

Next, internal configuration of the digital camera 1 will be described.

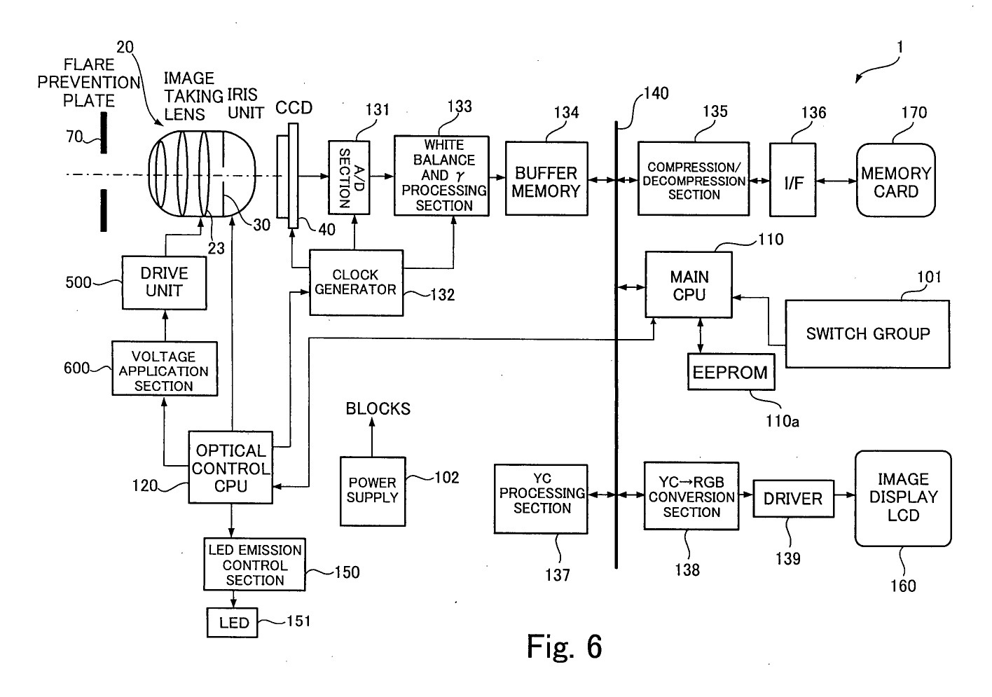

FIG. 6 is a schematic diagram showing an internal configuration of the digital camera 1 shown in FIG. 1.

The digital camera 1 has all its processes controlled by a main CPU 110. The main CPU 110 is supplied with operation signals from various switches (which include the shutter button 14 shown in FIG. 1, zoom control switch, and cross-key pad and will be referred to hereinafter collectively as a switch group 101) of the digital camera 1. The main CPU 110 has an EEPROM 110a which contains various programs needed to run various processes on the digital camera 1. When a power switch (not shown) in the switch group 101 is turned on, power is supplied to various components of the digital camera 1 from a power supply 102 and the main CPU 110 totally controls the entire operation of the digital camera 1 according to program procedures contained in the EEPROM 110a.

First, flow of an image signal will be described with reference to FIG. 6.

When a photographer specifies an angle of view using the cross-key pad (not shown) on the back of the digital camera 1, the specified angle of view is transmitted from the switch group 101 to an optical control CPU 120 via the main CPU 110. Incidentally, data are exchanged between the main CPU 110 and optical control CPU 120 at high speed via inter-CPU communications rather than via a bus 140. By controlling a motor (not shown) and the like, the optical control CPU 120 extends the lens barrel 10 as shown in FIGS. 4 and 5 and moves the rear-group lens 22 to a position corresponding to the angle of view specified by the photographer.

Also, by controlling the drive unit 500, the optical control CPU 120 moves the focus lens 23 shown in FIGS. 3, 4, and 5 along the optical axis.

A subject light passes through the flare prevention plate 70, image taking lens 20, and iris unit 30 and forms an image on the CCD 40, which then generates an image signal representing a subject image. The generated image signal is roughly read by an A/D section 131, which then converts an analog signal into a digital signal to generate low-resolution live view data. The generated live view data are subjected to image processing such as white balance correction and γ correction by a white balance and γ processing section 133.

The CCD 40 generates the image signal at predetermined intervals in sync with a timing signal supplied from a clock generator 132. The clock generator 132 outputs the timing signal based on instructions transmitted from the main CPU 110 via the optical control CPU 120. In addition to the CCD 40, the timing signal is also supplied to the A/D section 131 and the white balance and γ processing section 133 in subsequent stages. Thus, the CCD 40, A/D section 131, and white balance and γ processing section 133 process the image signal in an orderly manner in sync with the timing signal generated by the clock generator 132.

After the image processing by the white balance and γ processing section 133, the image data are temporarily stored in a buffer memory 134. The low-resolution live view data stored in the buffer memory 134 are supplied to a YC/RGB conversion section 138 via the bus 140 in the order in which they are stored. The live view data are provided as RGB signals, and thus they are not processed by the YC/RGB conversion section 138. Instead, they are transmitted directly to an image display LCD 160 via a driver 139, and live view from the live view data is displayed on the image display LCD 160. The CCD 40 reads a subject light and generates an image signal at predetermined intervals, and thus the a subject light coming from the direction in which the image taking lens is directed is displayed constantly on the image display LCD 160.

The live view data stored in the buffer memory 134 are also supplied to the main CPU 110. Based on the live view data, the main CPU 110 detects the contrast of the a subject light and luminance of the subject in the image signals obtained repeatedly by the CCD 40 while the focus lens 23 is moved along the optical axis. The detected contrast and luminance are transmitted to the optical control CPU 120. The optical control CPU 120 controls a voltage application section 600 which outputs a voltage to the drive unit 500 so as to move the focus lens 23 to a position where the contrast transmitted from the main CPU 110 reaches a peak (AF process).

The voltage application section 600 shown in FIG. 6 is an abstract representation of nine examples (described later) of the voltage application section. Each of the nine examples will be described in detail later.

The optical control CPU 120 adjusts an aperture value of the iris according to the luminance transmitted from the main CPU 110 (AE process).

The main CPU 110 is an example of the contrast detecting section according to the present invention. A combination of the voltage application section 600 and optical control CPU 120 corresponds to an example of the control section according to the present invention. A combination of the focus lens 23, drive unit 500, voltage application section 600, and optical control CPU 120 corresponds to an example of the optical controller according to the present invention.

When the photographer presses the shutter button 14 shown in FIG. 1 by checking the live view displayed on the image display LCD 160, the press of the shutter button 14 is transmitted to the main CPU 110 and further to the optical control CPU 120. If the subject is dark, the optical control CPU 120 gives an instruction for a flash to a LED emission control section 150 and a LED 151 flashes in sync with the press of the shutter button 14. Also, on instructions from the optical control CPU 120, the image signals generated by the CCD 40 are readout finely by the A/D section 131 to generate high-resolution photographic image data. The generated photographic image data is subjected to image processing by the white balance and γ processing section 133 and stored in the buffer memory 134.

The photographic image data stored in the buffer memory 134 is supplied to a YC processing section 137, where they are converted from an RGB signal to a YC signal. After the conversion into the YC signal, the photographic image data is subjected to a compression process by a compression/decompression section 135. The compressed photographic image data is stored in a memory card 170 via an interface 136.

The photographic image data stored in the memory card 170 is subjected to a decompression process by the compression/decompression section 135, converted into an RGB signal by the YC/RGB conversion section 138, and transmitted to the image display LCD 160 via the driver 139. The image display LCD 160 displays a photographic image from the photographic image data.

The digital camera 1 is configured as described above.

Next, description will be given of the first to ninth embodiments of the present invention.

The nine embodiments have the common configuration shown in FIGS. 1 to 6 except that each of them has a unique drive unit and voltage application section different from the drive unit 500 shown in FIGS. 3 to 6 and voltage application section 600 shown in FIG. 6. Thus, the description below will focus on the drive units and voltage application sections, which are different among the embodiments.

Incidentally, in the following description, the same components as those in FIGS. 3 to 6 will be denoted by the same reference numerals as the corresponding components in FIGS. 3 to 6.

To begin with, the first embodiment of the present invention will be described.

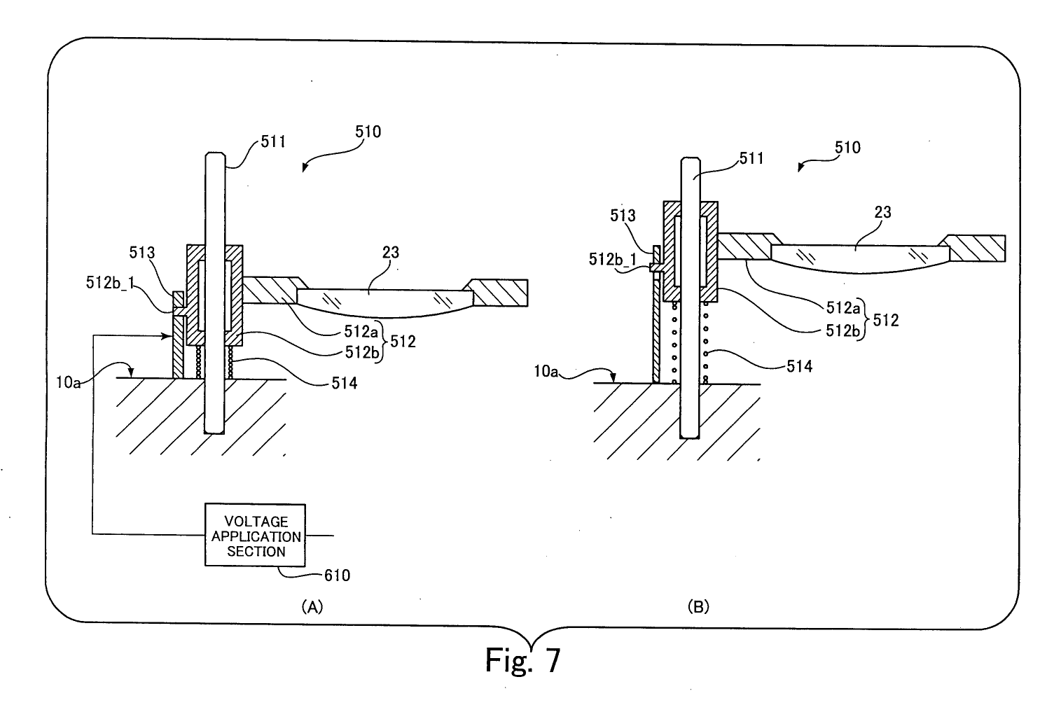

FIG. 7 is a diagram showing a drive unit and voltage application section according to the first embodiment of the present invention.

A drive unit 510 shown in FIG. 7 moves the focus lens 23 along the optical axis of the image taking lens 20 toward the CCD 40 (toward a wall 10a of the lens barrel 10) or toward the rear-group lens 22 in the opposite direction using a voltage outputted by a voltage application section 610. The voltage application section 610 outputs the voltage to the drive unit 510 under the control of the optical control CPU 120.

Part (A) of FIG. 7 shows a sectional view of the drive unit 510 according to the first embodiment of the present invention in its initial state and the voltage application section 610 according to the first embodiment. Part (B) of FIG. 7 shows a sectional view of the drive unit 510 during an AF process. Incidentally, the voltage application section 610 is omitted in Part (B) of FIG. 7.

The drive unit 510 has a guide bar 511, lens holding section 512, polymer actuator 513, and pusher spring 514.

The lens holding section 512, polymer actuator 513, and pusher spring 514 are examples of the holding section, polymer actuator, and driving section according to the present invention, respectively.

The guide bar 511 extends parallel to the optical axis of the image taking lens 20 and has one of its ends fixed to the wall 10a of the lens barrel 10.

The lens holding section 512 has a holder frame 512a which holds the focus lens 23 and a sleeve 512b which is installed on a flank of the holder frame 512a in such a way as to be integral with the holder frame 512a and through which the guide bar 511 is passed. The sleeve 512b of the lens holding section 512 has a projection 512b_1 on a flank.

A voltage outputted from the voltage application section 610 to the drive unit 510 is applied to the polymer actuator 513. The polymer actuator 513 has a sheet shape and when a voltage is applied from the voltage application section 610 during an AF process, it contracts in the direction along its thickness and expands along its surfaces. The amounts of expansion and contraction during voltage application increase as the magnitude of the applied voltage increases. Near one end of the polymer actuator 513 is a hole into which the projection 512b_1 of the sleeve 512b is inserted. The other end is fixed to the wall 10a of the lens barrel 10.

The pusher spring 514 is a coiled spring which is mounted in compression between the sleeve 512b and wall 10a.

In the initial state shown in Part (A) of FIG. 7, the pusher spring 514 is compressed by the polymer actuator 513.

When a voltage is applied by the voltage application section 610 during an AF process, the polymer actuator 513 contracts along its thickness and expands along its surfaces by amounts corresponding to the magnitude of the applied voltage as shown in Part (B) of FIG. 7. At this time, according to this embodiment, the pusher spring 514 is released by an amount proportional to the expansion of the polymer actuator 513 along its surfaces. Consequently, the pusher spring 514 pushes the sleeve 512b of the lens holding section 512, causing the focus lens 23 to move along the optical axis.

During the AF process, the focus lens 23 moves toward the rear-group lens 22 or CCD 40 according to rises and falls of the voltage applied to the polymer actuator 513.

Next, the polymer actuator 513 and voltage application section 610 shown in FIG. 7 will be described in detail.

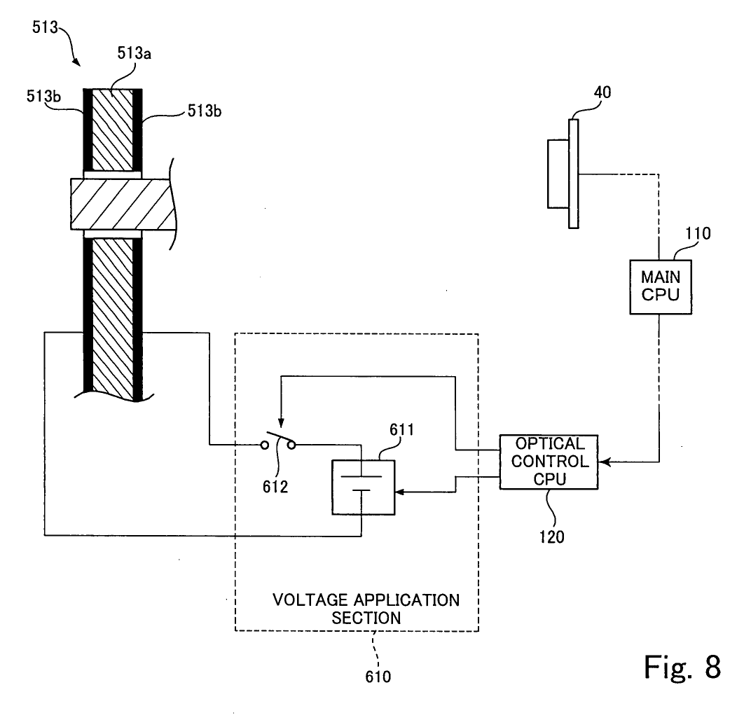

FIG. 8 is a diagram showing details of the polymer actuator 513 and voltage application section 610 shown in FIG. 7.

FIG. 8 shows a partially enlarged sectional view of the polymer actuator 513 and a circuit diagram of the voltage application section 610.

The polymer actuator 513 consists of a sheet-like electrostrictive polymer 513a sandwiched between elastic electrodes 513b. On the other hand, the voltage application section 610 has a DC power supply circuit 611 whose output voltage is variable between several hundred volts and several thousand volts and a switch 612, where the magnitude of the output voltage of the DC power supply circuit 611 and ON/OFF operation of the switch 612 are controlled by the optical control CPU 120.

According to this embodiment, when the AF process is started, the switch 612 is kept being turned on by the instruction of the optical control CPU 120 and remains on during the process. Consequently, a high voltage such as described above is applied between the two elastic electrodes 513b of the polymer actuator 513 from the DC power supply circuit 611 during the AF process. Then, electrostatic attraction is produced between the two elastic electrodes 513b, causing the polymer actuator 513 contract along its thickness and expand along its surfaces accordingly. The amounts of expansion and contraction of the polymer actuator 513 depend on the magnitude of the voltage applied between the two elastic electrodes 513b from the DC power supply circuit 611.

During the AF process, the output voltage of the DC power supply circuit 611 is raised and lowered under the control of the optical control CPU 120, causing the focus lens 23 to move toward the rear-group lens 22 or CCD 40. The control over the output voltage of the DC power supply circuit 611 by the optical control CPU 120 is feedback control performed in such a way that the contrast of the subject image detected by the main CPU 110 in the image signals acquired repeatedly by the CCD 40 will reach its peak. Consequently, the focus lens 23 is driven appropriately for focus adjustment.

Thus, in the drive unit 510 shown in FIG. 7, the role of driving the focus lens 23 is played by the pusher spring 514 and the polymer actuator 513. These two components are smaller in size and weight than, for example, a motor. Also, a mechanism which transmits the driving force from the pusher spring 514 and polymer actuator 513 to the focus lens 23 is very simple as well as small and lightweight, consisting of only the guide bar 511 and lens holding section 512. This makes the drive unit 510 small and lightweight, and consequently reduces the size and weight of the digital camera 1 shown in FIGS. 1 to 6. Besides, both the pusher spring 514 and polymer actuator 513 almost do not produce sounds during operation, which makes it possible to perform the AF process quietly.

Next, the second embodiment of the present invention will be described.

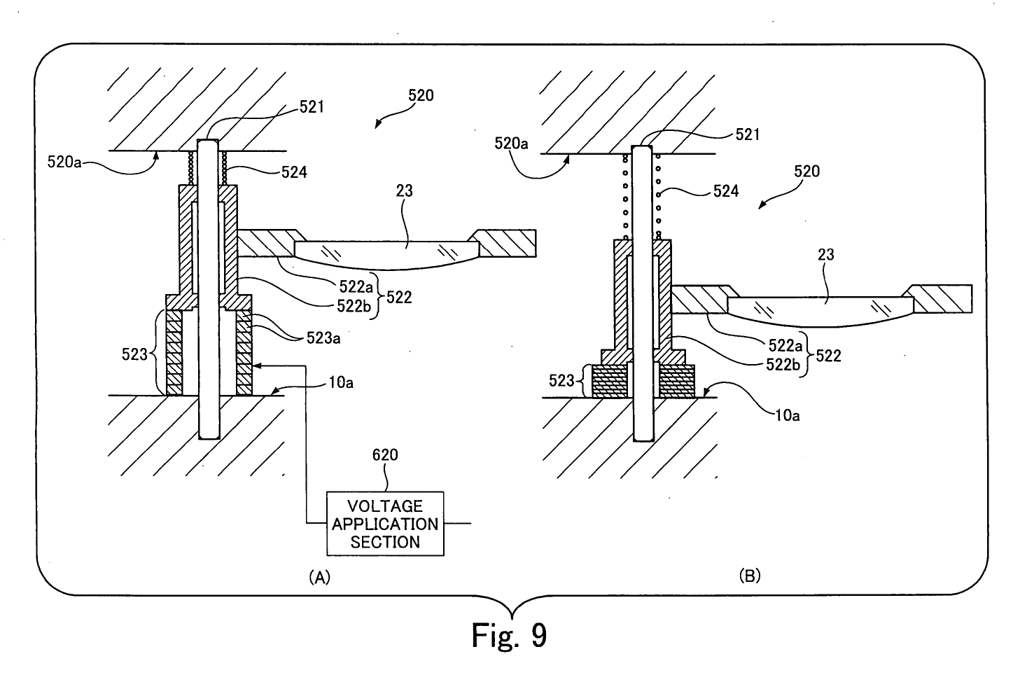

FIG. 9 is a diagram showing a drive unit and voltage application section according to the second embodiment of the present invention.

A drive unit 520 shown in FIG. 9 moves the focus lens 23 along the optical axis of the image taking lens 20 toward the CCD 40 (toward the wall 10a of the lens barrel 10) or toward the rear-group lens 22 (toward a wall 520a of the drive unit 520) in the opposite direction using a voltage outputted by a voltage application section 620. The voltage application section 620 outputs the voltage to the drive unit 520 under the control of the optical control CPU 120.

Part (A) of FIG. 9 shows a sectional view of the drive unit 520 according to the second embodiment of the present invention in its initial state and the voltage application section 620 according to the second embodiment. Part (B) of FIG. 9 shows a sectional view of the drive unit 520 during an AF process. Incidentally, the voltage application section 620 is omitted in Part (B) of FIG. 9.

The drive unit 520 has a guide bar 521, lens holding section 522, laminated polymer actuator 523, and pusher spring 524.

The lens holding section 522, laminated polymer actuator 523, and pusher spring 524 are examples of the holding section, laminated polymer actuator, and driving section according to the present invention, respectively.

The guide bar 521 extends parallel to the optical axis of the image taking lens 20 and has one of its ends fixed to the wall 10a of the lens barrel 10. The other end is fixed to the wall 520a of the drive unit 520 which faces the wall 10a of the lens barrel 10.

The lens holding section 522 has a holder frame 522a which holds the focus lens 23 and a sleeve 522b which is installed on a flank of the holder frame 522a in such a way as to be integral with the holder frame 522a and through which the guide bar 521 is passed.

The laminated polymer actuator 523 is made up of a stack of multiple elastic members 523a which expand and contract in response to application and release of a voltage. It is sandwiched between the sleeve 522b and wall 10a of the lens barrel 10. Each elastic member 523a has a hole in the center to pass the guide bar 521. Each of the elastic members 523a composing the laminated polymer actuator 523 is a small polymer actuator. A voltage to be applied to each elastic member 523a is outputted from the voltage application section 620 to the drive unit 520. The elastic members 523a are an example of the elastic member according to the present invention.

The pusher spring 524 is a coiled spring which is installed on the opposite side of the lens holding section 522 from the laminated polymer actuator 523 and mounted in compression between the sleeve 522b and the wall 520a of the drive unit 520.

In the initial state shown in Part (A) of FIG. 9, the pusher spring 524 is compressed by the laminated polymer actuator 523.

When a voltage is applied to each elastic member 523a of the laminated polymer actuator 523 by the voltage application section 620 during an AF process, the elastic member 523a contracts along its thickness and expands along its surfaces as shown in Part (B) of FIG. 9. At this time, according to this embodiment, the pusher spring 524 is released by an amount proportional to the contraction of the elastic members 523a along its thickness and the pusher spring 524 pushes the sleeve 522b of the lens holding section 522 accordingly. Consequently, the focus lens 23 moves along the optical axis. According to this embodiment, the magnitude of the voltage applied to each elastic member 523a by the voltage application section 620 is constant, and the amount of contraction of the entire laminated polymer actuator 523 and thus the amount of travel of the focus lens 23 depend on how many of the elastic members 523a are contracted by the application of voltage. Part (B) of FIG. 9 shows the laminated polymer actuator 523 in its fully contracted state, resulting from contraction of all the elastic members 523a composing the laminated polymer actuator 523.

During the AF process, increasing the number of contracted elastic members 523a causes the focus lens 23 to move toward the CCD 40 and decreasing the number of contracted elastic members 523a causes the focus lens 23 to move toward the rear-group lens 22.

Next, the laminated polymer actuator 523 and voltage application section 620 shown in FIG. 9 will be described in detail.

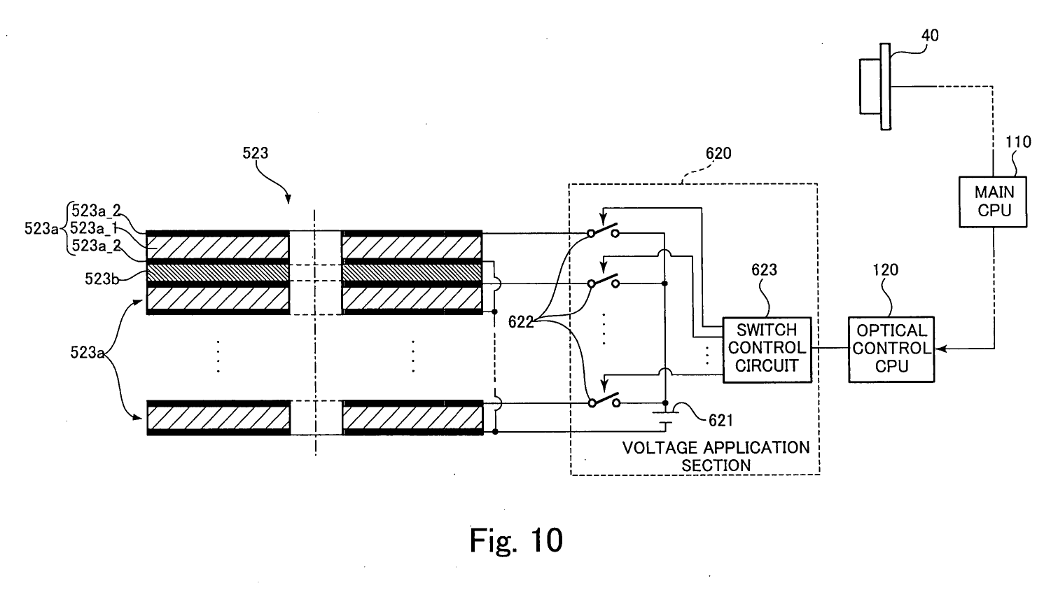

FIG. 10 is a diagram showing details of the laminated polymer actuator 523 and voltage application section 620 shown in FIG. 9.

FIG. 10 shows a partially enlarged sectional view of the laminated polymer actuator 523 and a circuit diagram of the voltage application section 620.

As described above, the laminated polymer actuator 523 consists of multiple elastic members 523a each of which is a small polymer actuator. Each elastic member 523a consists of a sheet-like electrostrictive polymer 523a_1 sandwiched between elastic electrodes 523_2. The laminated polymer actuator 523 is made up of a stack of multiple elastic members 523a with an insulating sheet 523b sandwiched between each pair of adjacent elastic members 523a.

The voltage application section 620 has a DC power supply 621 which outputs an output voltage of a predetermined value between several hundred volts and several thousand volts, multiple switches 622 installed between a positive terminal of the DC power supply 621 and electrodes 523a_2 of the elastic members 523a, and a switch control circuit 623 which controls ON/OFF operation of the switches 622 specified by the optical control CPU 120.

According to this embodiment, all the switches 622 are off in the initial state. When the AF process is started, the ON/OFF operation of each switch 622 is controlled by the switch control circuit 623 as required based on instructions from the optical control CPU 120. The elastic members 523a which correspond to activated switches 622 contract along their thickness, causing the entire laminated polymer actuator 523 to contract. As described above, the amount of contraction of the entire laminated polymer actuator 523 depends on the number of contracted elastic members 523a. Also, according to this embodiment, The determination as to which switches 622 should be turned on by the switch control circuit 623 is made by the optical control CPU 120. During the AF process, the number of contracted elastic members 523a is increased and decreased under the control of the optical control CPU 120, causing the focus lens 23 to move toward the rear-group lens 22 or CCD 40. The control performed by the optical control CPU 120 over the number of elastic members 523a to be contracted is feedback control performed in such a way that the contrast of the subject image detected by the main CPU 110 in the image signals acquired repeatedly by the CCD 40 will reach its peak. Consequently, the focus lens 23 is driven appropriately for focus adjustment.

In this way, in the drive unit 520 shown in FIG. 9, the role of driving the focus lens 23 is played by the pusher spring 524 and the laminated polymer actuator 523. These two components are small and lightweight, and so is a mechanism which transmits the driving force from the pusher spring 524 and polymer actuator 523 to the focus lens 23 as in the case of the first embodiment. This makes the drive unit 520 small and lightweight, which in turn makes it possible to perform the AF process quietly as in the case of the first embodiment again.

Next, the third embodiment of the present invention will be described.

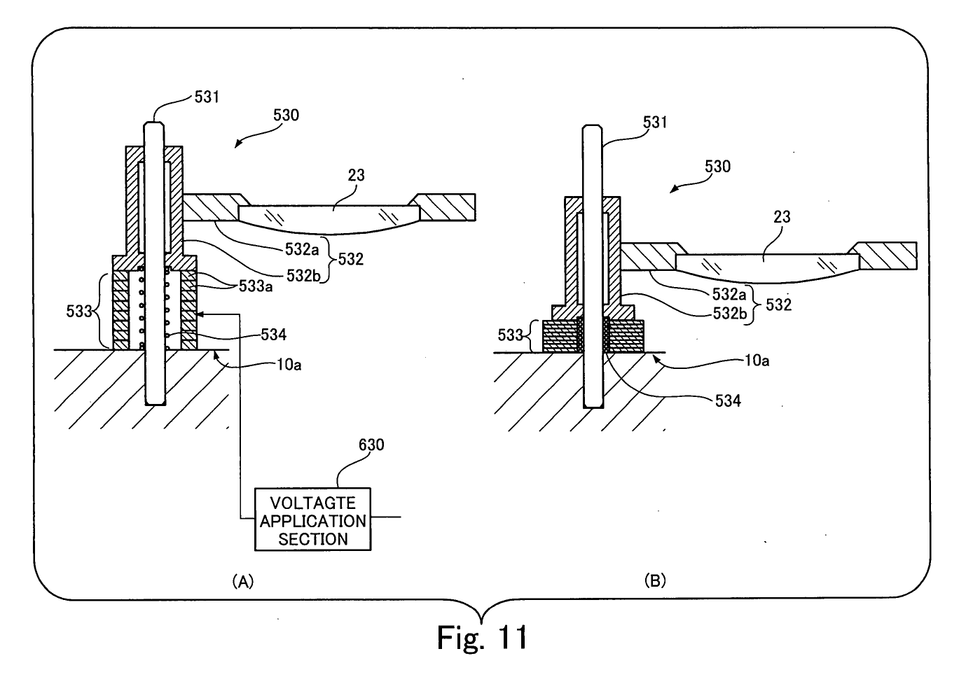

FIG. 11 is a diagram showing a drive unit and voltage application section according to the third embodiment of the present invention.

A drive unit 530 shown in FIG. 11 moves the focus lens 23 along the optical axis of the image taking lens 20 toward the CCD 40 (toward the wall 10a of the lens barrel 10) or toward the rear-group lens 22 in the opposite direction using a voltage outputted by a voltage application section 630. The voltage application section 630 outputs the voltage to the drive unit 530 under the control of the optical control CPU 120.

Part (A) of FIG. 11 shows a sectional view of the drive unit 530 according to the third embodiment of the present invention in its initial state and the voltage application section 630 according to the third embodiment. Part (B) of FIG. 11 shows a sectional view of the drive unit 530 during an AF process. Incidentally, the voltage application section 630 is omitted in Part (B) of FIG. 11.

The drive unit 530 has a guide bar 531, lens holding section 532, laminated polymer actuator 533, and tensile spring 534.

The lens holding section 532, laminated polymer actuator 533, and tensile spring 534 are examples of the holding section, laminated polymer actuator, and driving section according to the present invention, respectively.

The guide bar 531 extends parallel to the optical axis of the image taking lens 20 and has one of its ends fixed to the wall 10a of the lens barrel 10.

The lens holding section 532, laminated polymer actuator 533, and voltage application section 630 are the same, respectively, as the lens holding section 522, laminated polymer actuator 523, and voltage application section 620 according to the second embodiment described with reference to FIGS. 9 and 10, and thus redundant description thereof will be omitted.

The tensile spring 534 is a coiled spring which is passed through a hole in elastic members 533a of the laminated polymer actuator 533 with the guide bar 531 fitted over it. One end of the tensile spring is fixed to the sleeve 532b of the lens holding section 532. The other end is fixed to the wall 10a of the lens barrel 10.

In the initial state shown in Part (A) of FIG. 11, the tensile spring 534 is stretched by the laminated polymer actuator 533.

When a voltage is applied to each elastic member 533a of the laminated polymer actuator 533 by the voltage application section 630 during an AF process, the elastic member 533a contracts along its thickness and expands along its surfaces as shown in Part (B) of FIG. 11. At this time, according to this embodiment, the tensile spring 534 is released by an amount proportional to the contraction of the elastic members 533a along its thickness and the tensile spring 534 pulls the sleeve 532b of the lens holding section 532 accordingly. Consequently, the focus lens 23 held by a holder frame 532a of the lens holding section 532 moves along the optical axis. According to this embodiment, as in the case of the second embodiment, the amount of contraction of the entire laminated polymer actuator 533 and thus the amount of travel of the focus lens 23 depend on how many of the elastic members 533a are contracted by the application of voltage. Incidentally, Part (B) of FIG. 11 shows the laminated polymer actuator 533 in its fully contracted state.

During the AF process, increasing the number of contracted elastic members 533a causes the focus lens 23 to move toward the CCD 40 and decreasing the number of contracted elastic members 533a causes the focus lens 23 to move toward the rear-group lens 22.

The drive unit 530 according to the third embodiment described above is small and lightweight, making it possible to perform the AF process quietly, as in the case of the first and second embodiments described earlier.

Next, the fourth embodiment of the present invention will be described.

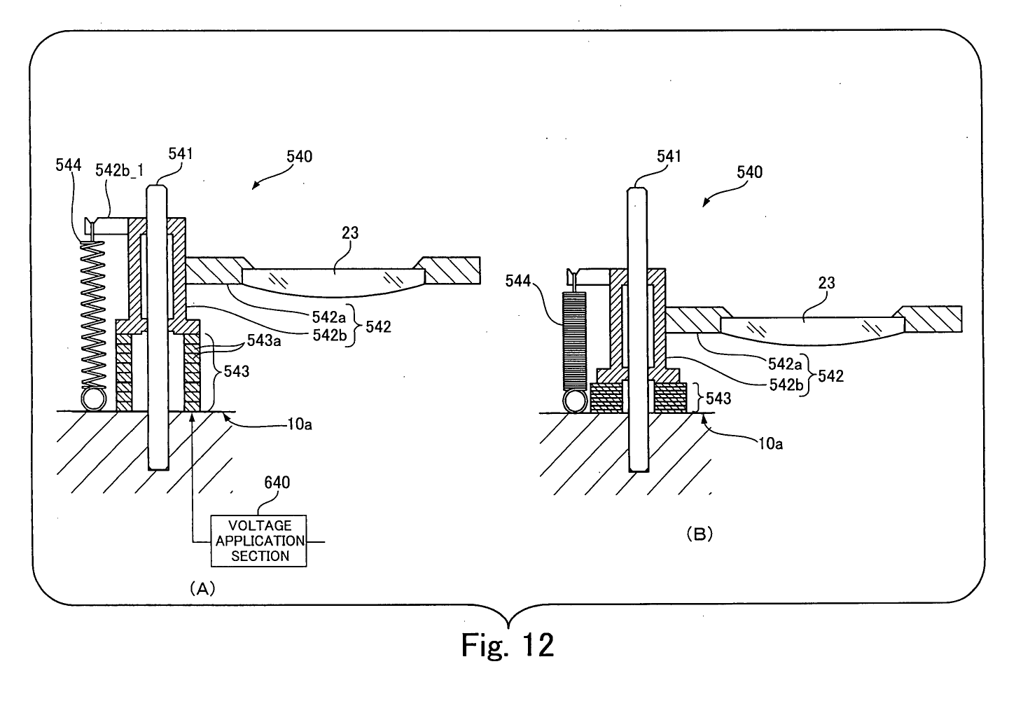

FIG. 12 is a diagram showing a drive unit and voltage application section according to the fourth embodiment of the present invention.

A drive unit 540 shown in FIG. 12 moves the focus lens 23 along the optical axis of the image taking lens 20 toward the CCD 40 (toward the wall 10a of the lens barrel 10) or toward the rear-group lens 22 in the opposite direction using a voltage outputted by a voltage application section 640. The voltage application section 640 outputs the voltage to the drive unit 540 under the control of the optical control CPU 120.

Part (A) of FIG. 12 shows a sectional view of the drive unit 540 according to the fourth embodiment of the present invention in its initial state and the voltage application section 640 according to the fourth embodiment. Part (B) of FIG. 12 shows a sectional view of the drive unit 540 during an AF process. Incidentally, the voltage application section 640 is omitted in Part (B) of FIG. 12.

The drive unit 540 has a guide bar 541, lens holding section 542, laminated polymer actuator 543, and tensile spring 544.

The lens holding section 542, laminated polymer actuator 543, and tensile spring 544 are examples of the holding section, laminated polymer actuator, and driving section according to the present invention, respectively.

The guide bar 541, lens holding section 542, laminated polymer actuator 543, and voltage application section 640 are almost the same, respectively, as the guide bar 531, lens holding section 532, laminated polymer actuator 533, and voltage application section 630 according to the third embodiment described with reference to FIG. 11, and thus redundant description thereof will be omitted. However, the lens holding section 542 according to this embodiment differs from the lens holding section 532 according to the third embodiment in that an arm section 542b_1 is attached to a sleeve 542b as shown in FIG. 12.

The tensile spring 544 is a coiled spring installed beside the lens holding section 542. One of its ends is hooked on the arm section 542b_1 and the other end is fixed to the wall 10a of the lens barrel 10.

In the initial state shown in Part (A) of FIG. 12, the tensile spring 544 is stretched by the laminated polymer actuator 543.

When a voltage is applied to each elastic member 543a of the laminated polymer actuator 543 by the voltage application section 640 during an AF process, the elastic member 543a contracts along its thickness and expands along its surfaces as shown in Part (B) of FIG. 12. At this time, according to this embodiment, the tensile spring 544 is released by an amount proportional to the contraction of the elastic members 543a along its thickness and the tensile spring 544 pulls the sleeve 542b of the lens holding section 542 accordingly. Consequently, the focus lens 23 held by a holder frame 542a of the lens holding section 542 moves along the optical axis. According to this embodiment, as in the case of the second and third embodiments, the amount of contraction of the entire laminated polymer actuator 543 and thus the amount of travel of the focus lens 23 depend on how many of the elastic members 543a are contracted by the application of voltage. Incidentally, Part (B) of FIG. 11 shows the laminated polymer actuator 543 in its fully contracted state.

During the AF process, increasing the number of contracted elastic members 543a causes the focus lens 23 to move toward the CCD 40 and decreasing the number of contracted elastic members 543a causes the focus lens 23 to move toward the rear-group lens 22.

The drive unit 540 according to the fourth embodiment described above is small and lightweight, making it possible to perform the AF process quietly, as in the case of the first to third embodiments described earlier.

Next, the fifth embodiment of the present invention will be described.

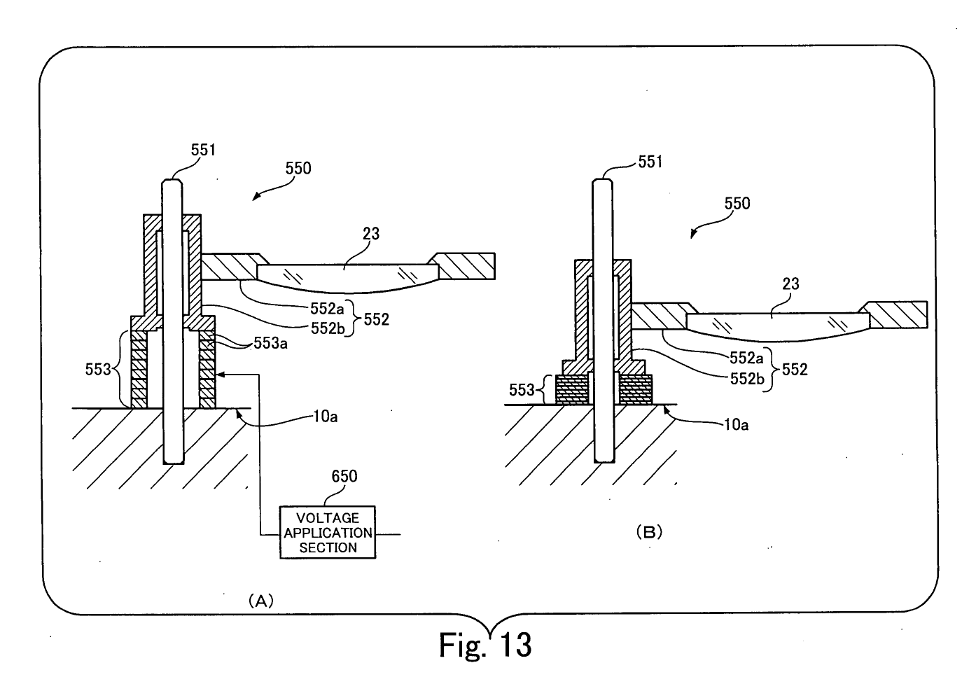

FIG. 13 is a diagram showing a drive unit and voltage application section according to the fifth embodiment of the present invention.

A drive unit 540 shown in FIG. 13 moves the focus lens 23 along the optical axis of the image taking lens 20 toward the CCD 40 (toward the wall 10a of the lens barrel 10) or toward the rear-group lens 22 in the opposite direction using a voltage outputted by a voltage application section 650. The voltage application section 650 outputs the voltage to the drive unit 550 under the control of the optical control CPU 120.

Part (A) of FIG. 13 shows initial state of the drive unit 550 according to the fifth embodiment of the present invention and the voltage application section 650 according to the fifth embodiment. Part (B) of FIG. 13 shows a sectional view of the drive unit 550 during an AF process. Incidentally, the voltage application section 650 is omitted in Part (B) of FIG. 13.

The drive unit 550 has a guide bar 551, lens holding section 552, and laminated polymer actuator 553.

The lens holding section 552 and laminated polymer actuator 553 are examples of the holding section and laminated polymer actuator according to the present invention, respectively.

The guide bar 551, lens holding section 552, laminated polymer actuator 553, and voltage application section 650 are almost the same, respectively, as the guide bar 531, lens holding section 532, laminated polymer actuator 533, and voltage application section 630 according to the third embodiment described with reference to FIG. 11, and thus redundant description thereof will be omitted. However, the laminated polymer actuator 553 according to this embodiment differs from the laminated polymer actuator 533 according to the third embodiment in the following points.

Each of elastic members 553a composing the laminated polymer actuator 553 according to this embodiment is bonded with adjoining ones by an insulating adhesive. Furthermore, the elastic member 553a closest to the lens holding section 552 is bonded to a sleeve 552b of the lens holding section 552 and the elastic member 553a closest to the wall 10a of the lens barrel 10 is bonded to the wall 10a of the lens barrel 10.

Thus, according to this embodiment, unlike the first to fourth embodiments, the lens holding section 552 can be pushed and pulled by expansion and contraction of the laminated polymer actuator 553 alone without the aid of a spring to drive the focus lens 23 held in a holder frame 552a of the lens holding section 552. Incidentally, Part (B) of FIG. 13 shows the laminated polymer actuator 553 in its fully contracted state.

During the AF process, increasing the number of contracted elastic members 553a causes the focus lens 23 to move toward the CCD 40 and decreasing the number of contracted elastic members 553a causes the focus lens 23 to move toward the rear-group lens 22.

The drive unit 550 according to the fifth embodiment described above is small and lightweight, making it possible to perform the AF process quietly, as in the case of the first to fourth embodiments described earlier.

Next, the sixth embodiment of the present invention will be described.

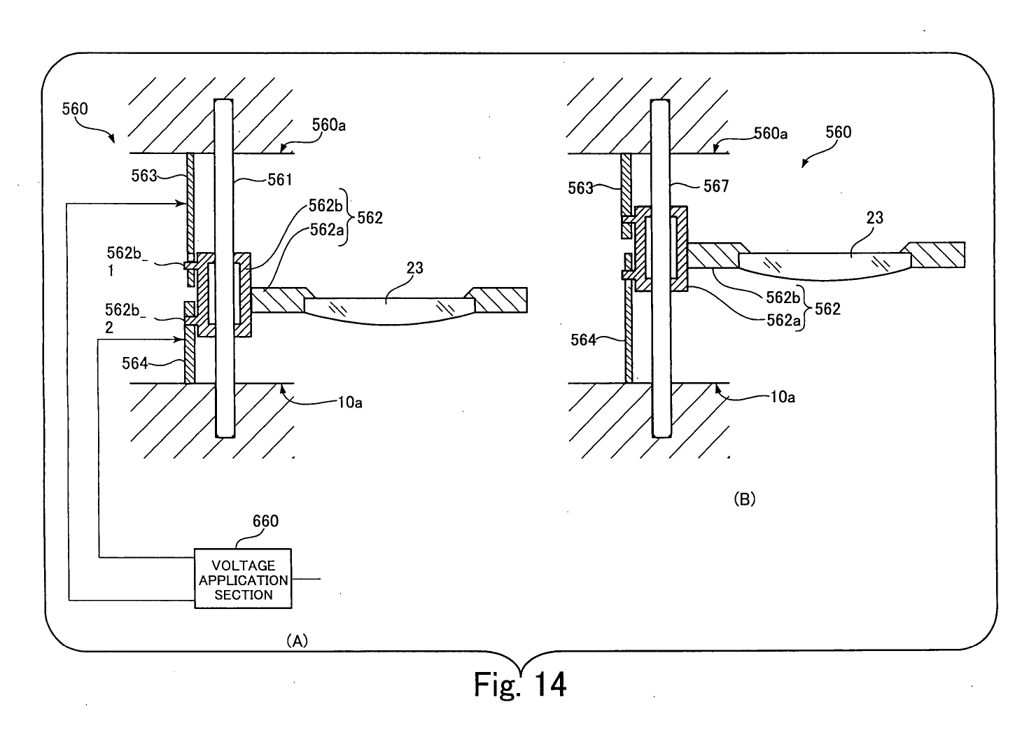

FIG. 14 is a diagram showing a drive unit and voltage application section according to the sixth embodiment of the present invention.

A drive unit 560 shown in FIG. 14 moves the focus lens 23 along the optical axis of the image taking lens 20 toward the CCD 40 (toward the wall 10a of the lens barrel 10) or toward the rear-group lens 22 (toward a wall 560a of the drive unit 560) in the opposite direction using a voltage outputted by a voltage application section 660. The voltage application section 660 outputs the voltage to the drive unit 560 under the control of the optical control CPU 120.

Part (A) of FIG. 14 shows a sectional view in which the focus lens 23 is moved toward the CCD 40 during an AF process by the drive unit 560 according to the sixth embodiment of the present invention. It also shows the voltage application section 660 according to the sixth embodiment. Part (B) of FIG. 14 shows a sectional view in which the focus lens 23 is moved toward the rear-group lens 22. Incidentally, the voltage application section 660 is omitted in Part (B) of FIG. 14.

The drive unit 560 has a guide bar 561, lens holding section 562, first polymer actuator 563, and second polymer actuator 564.

The lens holding section 562, first polymer actuator 563, and second polymer actuator 564 are examples of the holding section, polymer actuator, and driving section according to the present invention, respectively.

The guide bar 561 extends parallel to the optical axis of the image taking lens 20 and has one of its ends fixed to the wall 10a of the lens barrel 10. The other end is fixed to the wall 560a of the drive unit 560 which faces the wall 10a of the lens barrel 10.

The lens holding section 562 has a holder frame 562a which holds the focus lens 23 and a sleeve 562b which is installed on a flank of the holder frame 562a in such a way as to be integral with the holder frame 562a and through which the guide bar 561 is passed. The sleeve 562b of the lens holding section 562 has a first projection 562b_1 installed on a flank near the wall 560a of the drive unit 560 and a second projection 562b_2 installed near the wall 10a of the lens barrel 10.

Both the first polymer actuator 563 and second polymer actuator 564 are of the same type as the polymer actuator according to the first embodiment.

Near one end of the first polymer actuator 563 is a hole into which the first projection 562b_1 of the sleeve 562b is inserted. The other end is fixed to the wall 560a of the drive unit 560. Also, near one end of the second polymer actuator 564 is a hole into which the second projection 562b_2 of the sleeve 562b is inserted. The other end is fixed to the wall 10a of the lens barrel 10. In this structure, the first and second polymer actuators 563 and 564 are located across the lens holding section 562 from each other, pulling the lens holding section 562 in opposite directions.

In an initial state (not shown), the focus lens 23 held in the lens holding section 562, i.e., in the holder frame 562a, rests at a position where pulling forces due to elasticity of the two polymer actuators 563 and 564 without any voltage applied from the voltage application section 660 are in balance.

When voltages are applied by the voltage application section 660 during an AF process, the two polymer actuators 563 and 564 contract along their thickness and expand along their surfaces by amounts corresponding to the magnitudes of the applied voltages as shown in Part (A) or (B) of FIG. 14. At this time, according to this embodiment, the magnitude of the voltage applied to each polymer actuator 563 or 564 is adjusted to adjust the pulling force exerted on the lens holding section 562 by the polymer actuator 563 or 564.

During the AF process, the second polymer actuator 564 is expanded by an amount smaller than that of the first polymer actuator 563 as shown in Part (A) of FIG. 14, thereby increasing the pulling force of the second polymer actuator 564 and causing the focus lens 23 to move toward the CCD 40 or the first polymer actuator 563 is expanded by an amount smaller than that of the second polymer actuator 564 as shown in Part (B) of FIG. 14, thereby increasing the pulling force of the first polymer actuator 563 and causing the focus lens 23 to move toward the rear-group lens 22.

Next, the two polymer actuators 563 and 564 and voltage application section 660 shown in FIG. 14 will be described in detail.

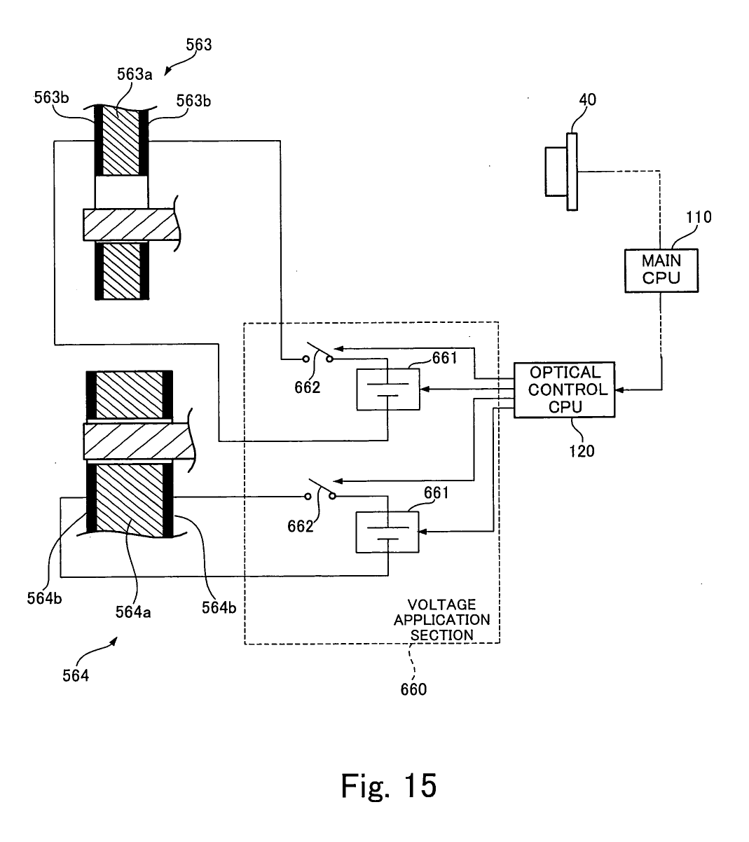

FIG. 15 is a diagram showing details of the two polymer actuators 563 and 564 and voltage application section 660 shown in FIG. 14.

FIG. 15 shows partially enlarged sectional views of the two polymer actuators 563 and 564 and a circuit diagram of the voltage application section 660.

As described above, the two polymer actuators 563 and 564 are of the same type. Each of them consists of a sheet-like electrostrictive polymer 563a or 564a sandwiched between elastic electrodes 563b or 564b.

The voltage application section 660 has two circuit portions which apply voltages to the two polymer actuators 563 and 564, respectively. As in the case of the voltage application section 610 according to the first embodiment shown in FIG. 7, each circuit portion has a DC power supply circuit 661 whose output voltage is variable between several hundred volts and several thousand volts and a switch 662, where the magnitude of the output voltage of the DC power supply circuit 661 and ON/OFF operation of the switch 662 are controlled by the optical control CPU 120.

According to this embodiment, when the AF process is started, the switch 662 is kept being turned on by the instruction of the optical control CPU 120 and remains on during the process. Then voltages are applied to the polymer actuators by the respective DC power supply circuits 661. Consequently, the two polymer actuators 563 and 564 contract along their thickness and expand along their surfaces by amounts corresponding to the magnitudes of the output voltages of the respective DC power supply circuits 661. In so doing, the polymer actuator with the smaller applied voltage and smaller amount of expansion pulls the lens holding section 562 more strongly, causing the lens holding section 562, and thus the focus lens 23, to move toward the polymer actuator with the smaller applied voltage.

During the AF process, the voltages applied to the polymer actuators 563 and 564 by the respective DC power supply circuits 661 are varied, causing the focus lens 23 to move toward the rear-group lens 22 or CCD 40. The magnitudes of the output voltages of the DC power supply circuits 661 are controlled through feedback control performed by the optical control CPU 120 in such a way that the contrast of the subject image detected by the main CPU 110 in the image signals acquired repeatedly by the CCD 40 will reach its peak. Consequently, the focus lens 23 is driven appropriately for focus adjustment.

The drive unit 560 according to the sixth embodiment described above is small and lightweight, making it possible to perform the AF process quietly, as in the case of the first to fifth embodiments described earlier.

Next, the seventh embodiment of the present invention will be described.

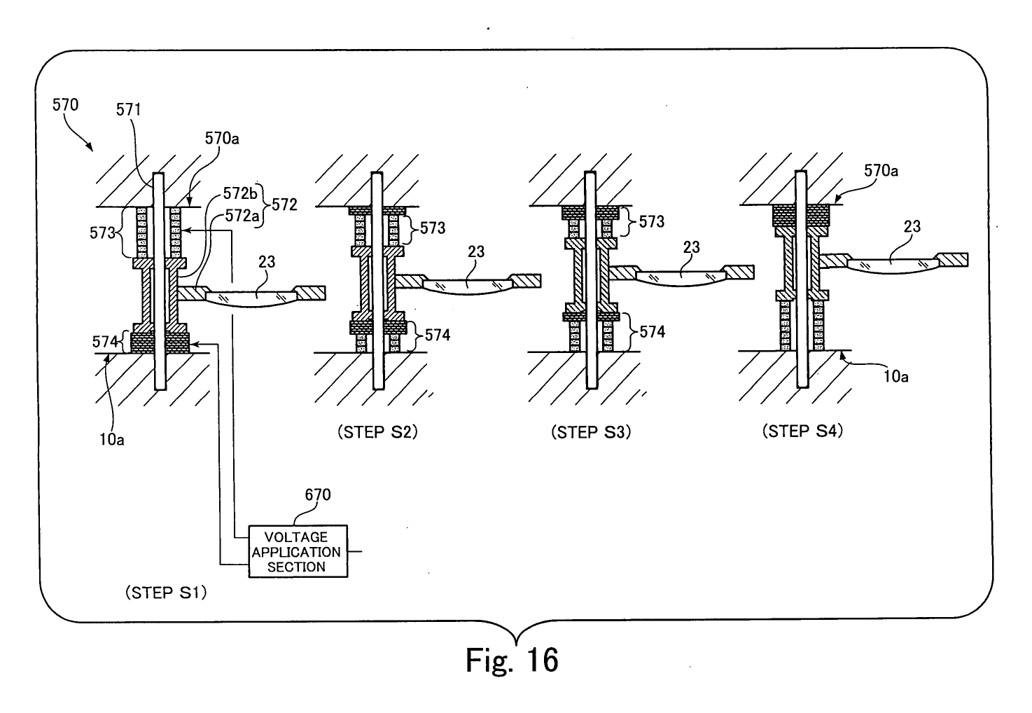

FIG. 16 is a diagram showing a drive unit and voltage application section according to the seventh embodiment of the present invention.

A drive unit 570 shown in FIG. 16 moves the focus lens 23 along the optical axis of the image taking lens 20 toward the CCD 40 (toward the wall 10a of the lens barrel 10) or toward the rear-group lens 22 (toward a wall 570a of the drive unit 570) in the opposite direction using a voltage outputted by a voltage application section 670. The voltage application section 670 outputs the voltage to the drive unit 570 under the control of the optical control CPU 120.

FIG. 16 provides four sectional views of step S1 to step S4 which illustrate how the focus lens 23 is moved from the position closest to the CCD 40 to the position closest to the rear-group lens 22 by the drive unit 570 according to the seventh embodiment of the present invention during an AF process. Incidentally, in FIG. 16, the voltage application section 670 is shown only in step S1.

The drive unit 570 has a guide bar 571, lens holding section 572, first laminated polymer actuator 573, and second laminated polymer actuator 574.

The lens holding section 572, first laminated polymer actuator 573, and second laminated polymer actuator 574 are examples of the holding section, polymer actuator, and driving section according to the present invention, respectively.

The guide bar 571 extends parallel to the optical axis of the image taking lens 20 and has one of its ends fixed to the wall 10a of the lens barrel 10. The other end is fixed to the wall 570a of the drive unit 570 which faces the wall 10a of the lens barrel 10.

The lens holding section 572 has a holder frame 572a which holds the focus lens 23 and a sleeve 572b which is installed on a flank of the holder frame 572a in such a way as to be integral with the holder frame 572a and through which the guide bar 571 is passed.

The first laminated polymer actuator 573 and second laminated polymer actuator 574 are of the same type as the laminated polymer actuator according to the second to fifth embodiments.

According to this embodiment, the first laminated polymer actuator 573 is sandwiched between the sleeve 572b of the lens holding section 572 and the wall 570a of the drive unit 570 while the second laminated polymer actuator 574 is sandwiched between the sleeve 522b of the lens holding section 572 and wall 10a of the lens barrel 10. That is, the second laminated polymer actuator 574 which is an example of the driving section according to the present invention is installed on the opposite side of the lens holding section 572 from the first laminated polymer actuator 573. Consequently, the lens holding section 572 is pushed from the wall 570a of the drive unit 570 by elasticity of the first laminated polymer actuator 573 and pushed in the opposite direction by elasticity of the second laminated polymer actuator 574.

In an initial state (not shown), the lens holding section 572, i.e., the focus lens 23, rests at a position where pushing forces due to elasticity of the two laminated polymer actuators 573 and 574 without any voltage applied from the voltage application section 670 are in balance.

When voltages are applied to the two laminated polymer actuators 573 and 574 by the voltage application section 670 during an AF process, some elastic members of the laminated polymer actuators 573 and 574 contract.

According to this embodiment, as shown in FIG. 16, the number of contracted elastic members in one of the laminated polymer actuators 573 and 574 agrees with the number of non-contracted elastic members in the other of the laminated polymer actuators 573 and 574. For example, in step S1 of FIG. 16, all the eight elastic members in the first laminated polymer actuator 573 are not contracted while all the eight elastic members in the second laminated polymer actuator 574 are contracted. In step S2, three elastic members in the first laminated polymer actuator 573 are not contracted and three elastic members in the second laminated polymer actuator 574 are contracted. In step S3, five elastic members in the first laminated polymer actuator 573 are not contracted and five elastic members in the second laminated polymer actuator 574 are contracted. In step S4, all the eight elastic members in the first laminated polymer actuator 573 are contracted while all the eight elastic members in the second laminated polymer actuator 574 are not contracted.

During the AF process, if the number of contracted elastic members in the first laminated polymer actuators 573 is increased and the number of contracted elastic members in the second laminated polymer actuators 574 is decreased, the focus lens 23 moves toward the rear-group lens 22. If the number of contracted elastic members in the first laminated polymer actuators 573 is decreased and the number of contracted elastic members in the second laminated polymer actuators 574 is increased, the focus lens 23 moves toward the CCD 40.

Next, the two laminated polymer actuators 573 and 574 and voltage application section 670 shown in FIG. 16 will be described in detail.

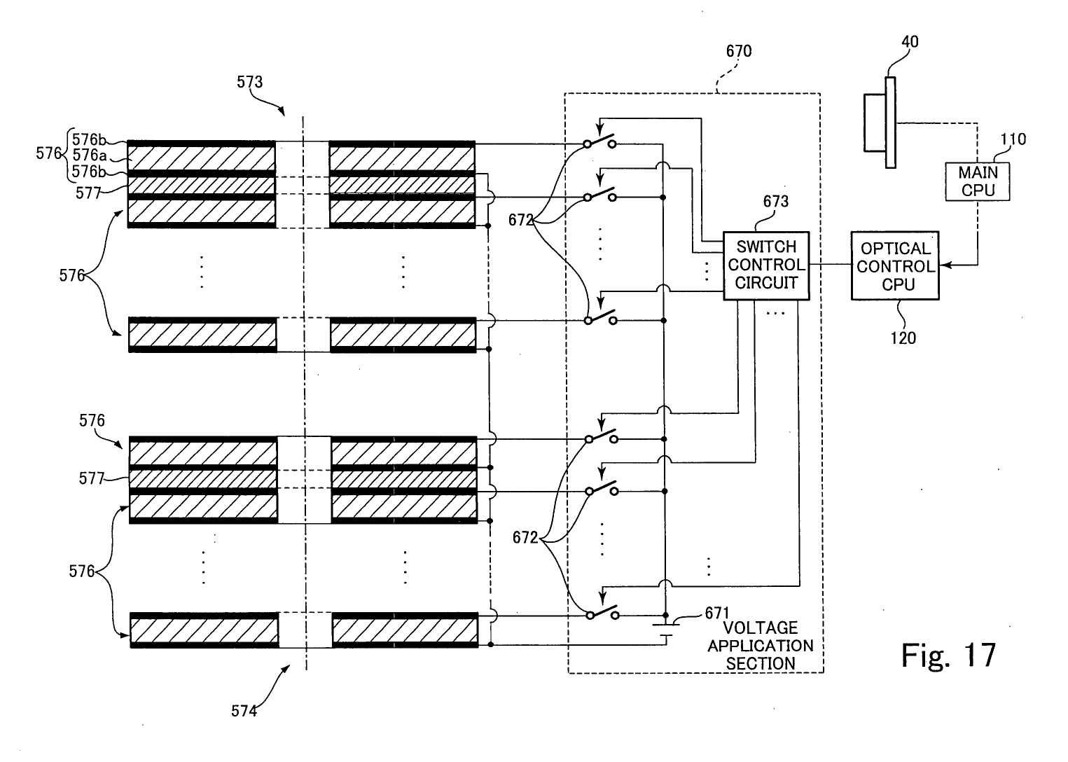

FIG. 17 is a diagram showing details of the two laminated polymer actuators 573 and 574 and voltage application section 670 shown in FIG. 16.

FIG. 17 shows partially enlarged sectional views of the two laminated polymer actuators 573 and 574 and a circuit diagram of the voltage application section 670.

Both the first laminated polymer actuator 573 and second laminated polymer actuator 574 consist of multiple elastic members 576 each of which is a small polymer actuator. Each elastic member 576 consists of a sheet-like electrostrictive polymer 576a sandwiched between elastic electrodes 576b. Each laminated polymer actuator 573 or 574 is made up of a stack of multiple elastic members 576 with an insulating sheet 577 sandwiched between each pair of adjacent elastic members 576.

The voltage application section 670 has a DC power supply 671 which outputs an output voltage of a predetermined value between several hundred volts and several thousand volts, multiple switches 672 installed between a positive terminal of the DC power supply 671 and electrodes 576b of the elastic members 576 of the two laminated polymer actuators 573 and 574, and a switch control circuit 673 which controls ON/OFF operation of the switches 672 specified by the optical control CPU 120.

According to this embodiment, all the switches 672 are off in the initial state. When the AF process is started, the ON/OFF operation of each switch 672 is controlled by the switch control circuit 673 as required based on instructions from the optical control CPU 120, thereby expanding and contracting the first laminated polymer actuator 573 and second laminated polymer actuator 574. The switches 672 are controlled such that the number of activated switches 672 in one of the laminated polymer actuators 573 and 574 will agree with the number of deactivated switches 672 in the other of the laminated polymer actuators 573 and 574. Consequently, the lens holding section 572, i.e., the focus lens 23, is moved with a balance maintained between the pushing forces of the first and second laminated polymer actuators 573 and 574 against the lens holding section 572.

During the AF process, the numbers of activated switches 672 and deactivated switches 672 of the two laminated polymer actuators 573 and 574 are increased and decreased under the control of the optical control CPU 120, causing the focus lens 23 to move toward the rear-group lens 22 or CCD 40. The control by the optical control CPU 120 is feedback control performed in such a way that the contrast of the subject image detected by the main CPU 110 in the image signals acquired repeatedly by the CCD 40 will reach its peak. Consequently, the focus lens 23 is driven appropriately for focus adjustment.

The drive unit 570 according to the seventh embodiment described above is small and lightweight, making it possible to perform the AF process quietly, as in the case of the first to sixth embodiments described earlier.

Next, the eighth embodiment of the present invention will be described.

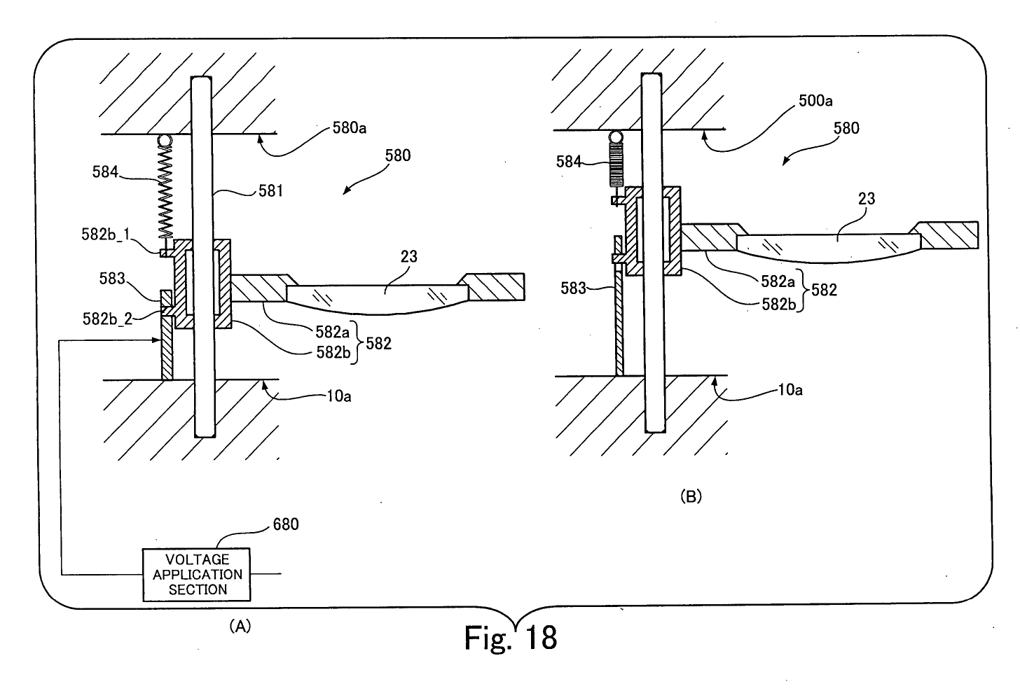

FIG. 18 is a diagram showing a drive unit and voltage application section according to the eighth embodiment of the present invention.

A drive unit 580 shown in FIG. 18 moves the focus lens 23 along the optical axis of the image taking lens 20 toward the CCD 40 (toward the wall 10a of the lens barrel 10) or toward the rear-group lens 22 (toward a wall 580a of the drive unit 580) in the opposite direction using a voltage outputted by a voltage application section 680. The voltage application section 680 outputs the voltage to the drive unit 580 under the control of the optical control CPU 120.

Part (A) of FIG. 18 shows initial state of the drive unit 580 according to the eighth embodiment of the present invention and the voltage application section 680 according to the eighth embodiment. Part (B) of FIG. 18 shows a sectional view of the drive unit 580 during an AF process. Incidentally, the voltage application section 680 is omitted in Part (B) of FIG. 18.

The drive unit 580 has a guide bar 581, lens holding section 582, polymer actuator 583, and tensile spring 584.

The lens holding section 582, polymer actuator 583, and tensile spring 584 are examples of the holding section, polymer actuator, and driving section according to the present invention, respectively.

The guide bar 581 and lens holding section 582 are the same, respectively, as the guide bar 561 and lens holding section 562 according to the sixth embodiment described with reference to FIG. 14, and thus redundant description thereof will be omitted.

The polymer actuator 583 according to this embodiment is made of a liquid crystal elastomer unlike the polymer actuators according to the first to seventh embodiments which are made of an electrostrictive polymer. Configuration of the polymer actuator 583 made of a liquid crystal elastomer will be described later. Near one end of the polymer actuator 583 is a hole into which a second projection 582b_2 on a sleeve 582b of the lens holding section 582 is inserted, where the second projection 582b_2 is installed near the wall 10a of the lens barrel 10. The other end of the polymer actuator 583 is fixed to the wall 10a of the lens barrel 10.

The tensile spring 584 has one of its ends hooked on a first projection 582b_1 of the sleeve 582b near the wall 580a of the drive unit 580. The other end of the tensile spring 584 is fixed to the wall 580a of the drive unit 580. In this structure, the tensile spring 584 is located across the lens holding section 582 from the polymer actuator 583. Consequently, the lens holding section 582 is pulled in opposite directions by the tensile spring 584 and polymer actuator 583.

In the initial state shown in Part (A) of FIG. 18, the tensile spring 584 is stretched by the polymer actuator 583.

When a voltage is applied by the voltage application section 680 during an AF process, the polymer actuator 583 contracts along its thickness and expands along its surfaces by amounts corresponding to the magnitude of the applied voltage as shown in Part (B) of FIG. 18. At this time, according to this embodiment, the tensile spring 584 is released by an amount proportional to the expansion of the polymer actuator 583 along its surfaces. Consequently, the tensile spring 584 pulls the sleeve 582b of the lens holding section 582, causing the focus lens 23 to move along the optical axis.

During the AF process, if the amount of expansion along the surfaces of the polymer actuator 583 is increased by raising the voltage applied to the polymer actuator 583, the focus lens 23 moves toward the rear-group lens 22. If the amount of expansion along the surfaces of the polymer actuator 583 is decreased by lowering the voltage applied to the polymer actuator 583, the focus lens 23 moves toward the CCD 40.

Next, the polymer actuator 583 and voltage application section 680 shown in FIG. 18 will be described in detail.

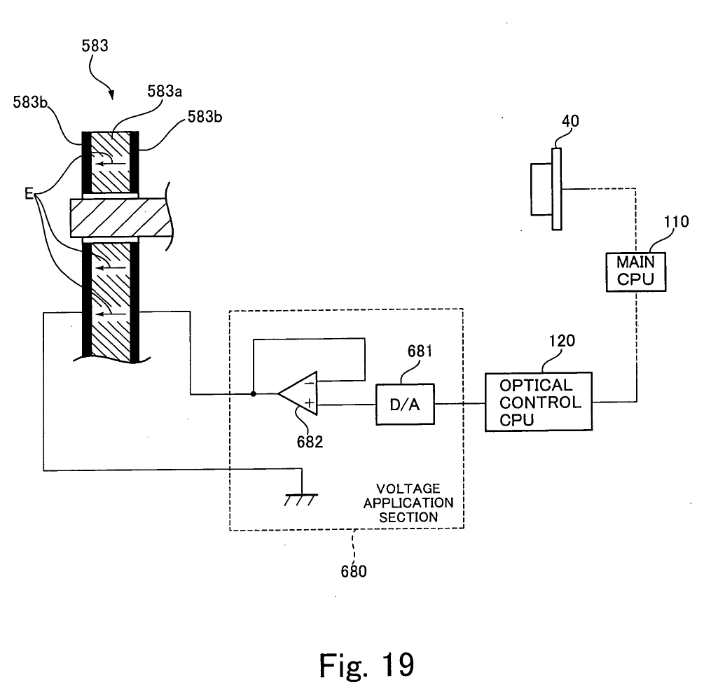

FIG. 19 is a diagram showing details of the polymer actuator 583 and voltage application section 680 shown in FIG. 18.

FIG. 19 shows a partially enlarged sectional view of the polymer actuator 583 and a circuit diagram of the voltage application section 680.

The polymer actuator 583 consists of a sheet-like liquid crystal elastomer 583a sandwiched between elastic electrodes 583b.

The liquid crystal elastomer 583a of the polymer actuator 583 has the property of deforming as follows when an electric field E is generated between the two electrodes 583b.

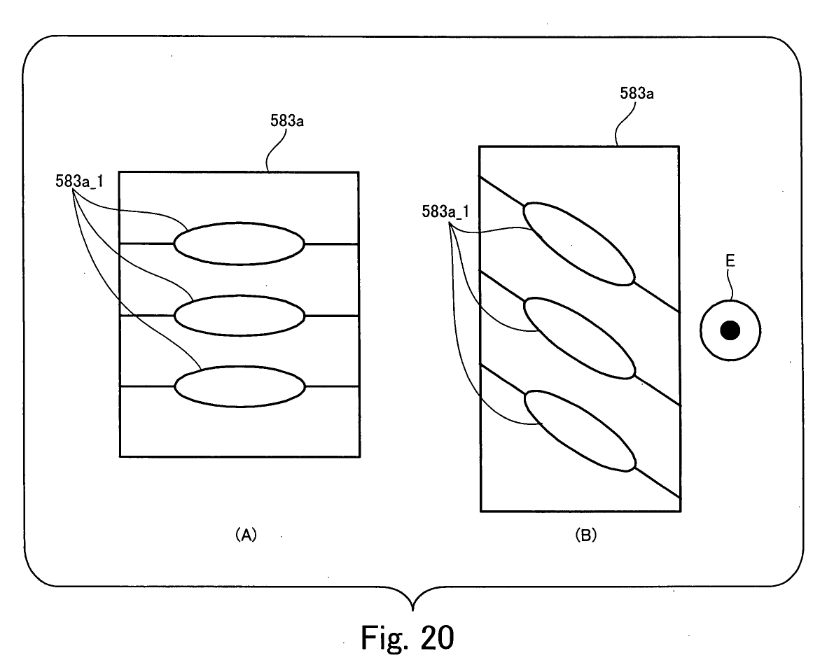

FIG. 20 is a diagram illustrating deformation of a liquid crystal elastomer in an electric field.

Part (A) of FIG. 20 schematically shows the liquid crystal elastomer 583a in its initial state in which no electric field is applied and Part (B) of FIG. 20 schematically shows the liquid crystal elastomer 583a deformed in an electric field E which is directed away from the viewer.

As shown in FIG. 20, the liquid crystal elastomer 583a contains a large number of mesogens (liquid crystal molecules) 583a_1 which are electrically anisotropic and change their orientation when placed in an electric field. Consequently, as shown in Part (B) of FIG. 20, when the liquid crystal elastomer 583a is placed in an electric field, it contracts in one direction (horizontal direction in Part (B) of FIG. 20) and expands in another direction (vertical direction in Part (B) of FIG. 20) according to orientation changes of mesogens 583a_1. The amounts of expansion and contraction depend on the strength of the electric field.

As shown in FIG. 19, the polymer actuator 583 according to this embodiment expands along its surfaces and contracts along its thickness as the liquid crystal elastomer 583a expands and contracts according to the strength of the electric field E formed according to the output voltage of the voltage application section 680 between the electrodes 583b which sandwich the liquid crystal elastomer 583a.

The voltage application section 680 has a D/A converter 681 and the buffer 682. Digital voltages based on digital values entered from the optical control CPU 120 are generated and converted into analog voltages by the D/A converter 681 and applied via the buffer 682 to one of the electrodes 583b sandwiching the liquid crystal elastomer 583a. The other electrode 583b is grounded in the voltage application section 680. Consequently, an electric field E proportional to the applied voltage is generated between the two electrodes 583b, causing the polymer actuator 583 to expand and contract by amounts corresponding to the strength of the electric field E, i.e., the digital values from the optical control CPU 120.

During the AF process, the optical control CPU 120 increases and decreases the digital values entered into the D/A converter 681 and thereby causes the focus lens 23 to move toward the rear-group lens 22 or CCD 40. The optical control CPU 120 performs feedback control over the digital values in such a way that the contrast of the subject image detected by the main CPU 110 in the image signals acquired repeatedly by the CCD 40 will reach its peak. Consequently, the focus lens 23 is driven appropriately for focus adjustment.

The drive unit 580 according to the eighth embodiment described above is small and lightweight, making it possible to perform the AF process quietly, as in the case of the first to seventh embodiments described earlier.

Next, the ninth embodiment of the present invention will be described.

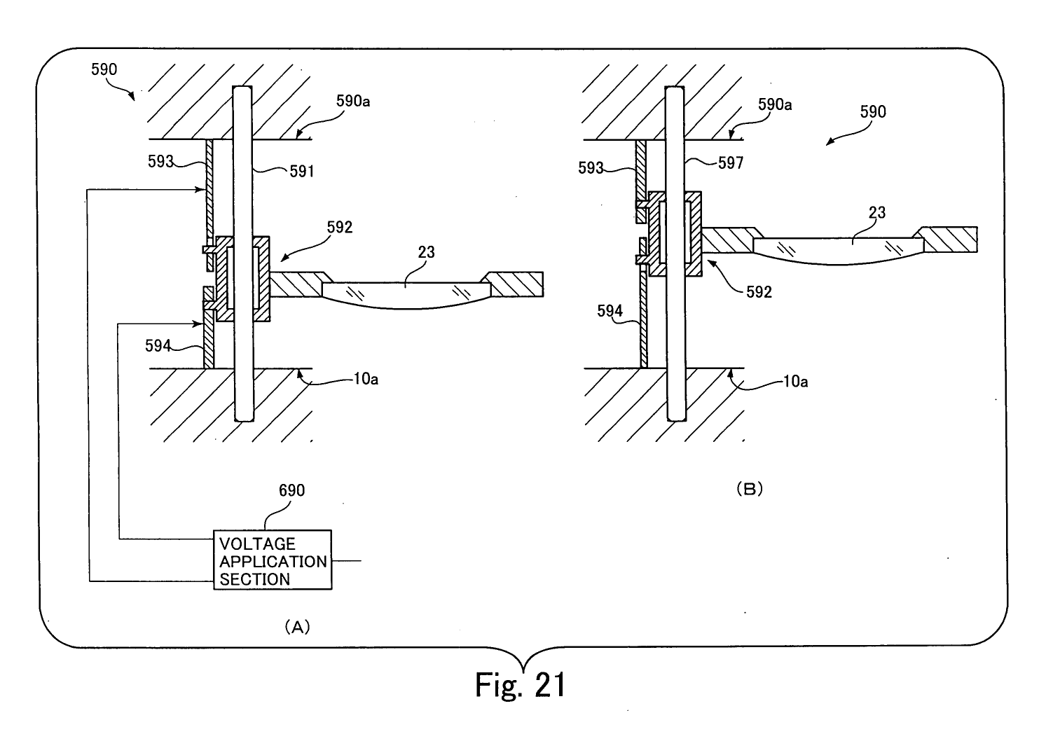

FIG. 21 is a diagram showing a drive unit and voltage application section according to the ninth embodiment of the present invention.

A drive unit 590 shown in FIG. 21 moves the focus lens 23 along the optical axis of the image taking lens 20 toward the CCD 40 (toward the wall 10a of the lens barrel 10) or toward the rear-group lens 22 (toward a wall 590a of the drive unit 590) in the opposite direction using a voltage outputted by a voltage application section 690. The voltage application section 690 outputs the voltage to the drive unit 590 under the control of the optical control CPU 120.

Part (A) of FIG. 21 shows a sectional view in which the focus lens 23 is moved toward the CCD 40 by the drive unit 590 according to the ninth embodiment of the present invention. It also shows the voltage application section 690 according to the ninth embodiment. Part (B) of FIG. 21 shows a sectional view in which the focus lens 23 is moved toward the rear-group lens 22. Incidentally, the voltage application section 690 is omitted in Part (B) of FIG. 21.

The drive unit 590 has a guide bar 591, lens holding section 592, first polymer actuator 593, and second polymer actuator 594.

The lens holding section 592, first polymer actuator 593, and second polymer actuator 594 are examples of the holding section, polymer actuator, and driving section according to the present invention, respectively.

The drive unit 590 according to this embodiment is the same, respectively, as the drive unit 560 according to the sixth embodiment described with reference to FIG. 14 except that the two polymer actuators 593 and 594 are made of a liquid crystal elastomer, and thus redundant description thereof will be omitted.

The description below will focus on the two polymer actuators 593 and 594 of the drive unit 590 according to this embodiment and the voltage application section 690 which applies voltage to the two polymer actuators.

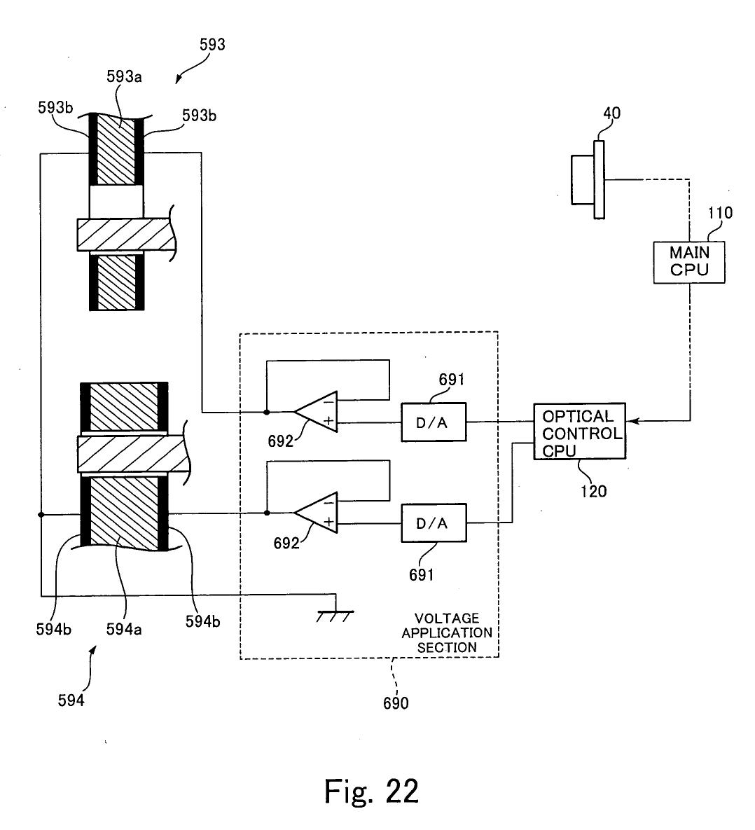

FIG. 22 is a diagram showing details of the two polymer actuators 593 and 594 and voltage application section 690 shown in FIG. 21.

FIG. 22 shows partially enlarged sectional views of the two polymer actuators 593 and 594 and a circuit diagram of the voltage application section 690.

The two polymer actuators 593 and 594 are of the same type. Each of them consists of a sheet-like electrostrictive polymer 593a or 594a sandwiched between elastic electrodes 593b or 594b.

The voltage application section 690 has two circuit portions which apply voltages to the two polymer actuators 593 and 594, respectively. Each circuit portion has a D/A converter 691 and the buffer 692 as in the case of the voltage application section 680 according to the eighth embodiment shown in FIG. 19. One of the electrodes of each polymer actuator is connected to the buffer 692 and the other electrode is grounded in the voltage application section 690.

In each circuit portion, digital voltages based on digital values entered from the optical control CPU 120 are generated and converted into analog voltages by the D/A converter 691 and applied to the appropriate polymer actuators via the buffer 692. Consequently, the two polymer actuators 593 and 594, contract along their thickness and expand along their surfaces by amounts proportional to the magnitudes of the applied voltages specified by the optical control CPU 120. In so doing, the polymer actuator with the smaller applied voltage and smaller amount of expansion pulls the lens holding section 592 more strongly, causing the lens holding section 592, and thus the focus lens 23, to move toward the polymer actuator with the smaller applied voltage.

During the AF process, the optical control CPU 120 varies the digital values entered into the D/A converters 691 for different circuit portions, thereby causing the focus lens 23 to move toward the rear-group lens 22 or CCD 40. The optical control CPU 120 performs feedback control of the digital value for each circuit portion in such a way that the contrast of the subject image detected by the main CPU 110 in the image signals acquired repeatedly by the CCD 40 will reach its peak. Consequently, the focus lens 23 is driven appropriately for focus adjustment.

The drive unit 590 according to the ninth embodiment described above is small and lightweight, making it possible to perform the AF process quietly, as in the case of the first to eighth embodiments described earlier.

Next, available forms of the polymer actuator according to the present invention will be described additionally.

Polymers available for use in polymer actuators include polymer gels, ion conducting polymers, electron conducting polymers, electrostrictive polymers (dielectric elastomers and electrostatic elastomers), piezoelectric polymers, and liquid crystal elastomers. Above all, electrostrictive polymers and liquid crystal elastomers are preferable. Polymer actuators are described in “Forefront in the Development of Soft Actuators—toward Realization of Artificial Muscles,” Yoshihito Osada, et al., NTS, 2004; “Electroactive Polymer (EAP) Actuators as Artificial Muscles—Reality, Potential and Challenges,” Editor: Yoseph Bar-Cohen SPIE PRESS Vol. 2001; and “Electroactive Polymer (EAP) Actuators as Artificial Muscles: Reality, Potential, and Challenges, Second Edition,” Editor(s): Yoseph Bar-Cohen, posted in 2004.

Regarding electrostrictive polymers (dielectric elastomers), electrostrictive polymer actuators are known which have electrodes attached to both sides of a polymer (elastomer) that exhibits rubber-like viscoelastic behavior. For example, National Publication of International Patent Application No. 2003-506858 discloses an electrostrictive polymer actuator which has electrodes equipped with conformable contacts and capable of deforming under strain and which utilizes the characteristics of a polymer membrane to contract along an electric field and expand in a direction orthogonal to the electric field as a result of electrostatic attraction between the electrodes when a high voltage is applied between the electrodes. Possible applications of this actuator include diaphragms or linear actuators. Besides, National Publication of International Patent Application No. 2003-526213 discloses a heel-grounded generator incorporated in heels of footwear and used to convert mechanical energy generated during bipedal locomotion of man into electrical energy.

Regarding liquid crystal elastomers, Nature magazine, 410, 447 (2001) reports an attempt to convert electrical energy into mechanical energy using orientation changes of mesogens due to an electric field generated by a ferroelectric liquid crystal elastomer. This attempt attracts attention as a new application of liquid crystals. In this example, an applied voltage of 1.5 MVm⁻¹ achieves a displacement 4%. Also, Japanese Patent Laid-Open No. 2003-205496 discloses a liquid crystal actuator which uses a liquid crystal elastomer stretched along its length. Furthermore, Macromolecules, 34, 5868 (2001) reports the use of changes in the shape (volume) of liquid crystals due to thermally induced phase transition of the liquid crystals for an actuator.

Incidentally, only one type of polymer actuator has been described in relation to each of the embodiments described above: a polymer actuator made of an electrostrictive polymer or polymer actuator made of an liquid crystal elastomer. However, the present invention is not limited to this and each of the embodiments described above may employ either a polymer actuator made of an electrostrictive polymer or polymer actuator made of a liquid crystal elastomer.

Also, although the focus lens 23 has been cited in the above embodiments as an example of the lens according to the present invention driven by a polymer actuator, the present invention is not limited to this. The lens according to the present invention may be the rear-group lens 22 or a combination of the rear-group lens 22 and focus lens 23.

Also, although a digital camera has been cited as the image taking apparatus according to the present invention, the present invention is not limited to this. The image taking apparatus according to the present invention is applicable to camera-equipped cell phones and film cameras which focus a subject light on a film.

What is claimed is:

1. A drive unit comprising:
a holding section which holds a driven object and is movable in a driving direction of the driven object; and
a polymer actuator which drives the holding section in the driving direction by expanding and contracting in response to application and release of a voltage.

2. The drive unit according to claim 1, wherein the polymer actuator expands and contracts by amounts corresponding to a magnitude of the applied voltage.

3. The drive unit according to claim 1, wherein the polymer actuator is a laminated polymer actuator made up of a stack of multiple elastic members which expand and contract in response to application and release of a voltage.

4. The drive unit according to claim 1, wherein the polymer actuator is made of an electrostrictive polymer or liquid crystal elastomer.

5. The drive unit according to claim 1, further comprising a driving section which drives the holding section in the driving direction, in addition to the polymer actuator, wherein the driving section drives the holding section in the direction opposite to the driving direction of the holding section by the polymer actuator.

6. The drive unit according to claim 5, wherein the driving section is installed on an opposite side of the holding section from the polymer actuator.

7. The drive unit according to claim 5, wherein the driving section is a spring which drives the holding section by a biasing force.

8. The drive unit according to claim 5, wherein the driving section is a polymer actuator which drives the holding section by expanding and contracting in response to application and release of a voltage.

9. An optical controller comprising:
a lens to be driven;
a holding section which holds the lens and is movable in a driving direction of the lens;
a polymer actuator which drives the holding section in the driving direction by expanding and contracting in response to application and release of a voltage; and
a control section which controls a position of the lens by controlling application and release of a voltage with respect to the polymer actuator.

10. An image taking apparatus comprising:
a lens which is driven to focus a subject light
a holding section which holds the lens and is movable in a driving direction of the lens;
a polymer actuator which drives the holding section in the driving direction by expanding and contracting in response to application and release of a voltage;
a control section which controls a position of the lens by controlling application and release of a voltage with respect to the polymer actuator; and
an image taking section which shoots an image formed by the subject light through the lens.

11. The image taking apparatus according to claim 10, further comprising a contrast detecting section which detects contrast of the image shot by the image taking section, wherein the control section controls the position of the lens according to the contrast detected by the contrast detecting section.
